(19) United States
(12) Patent Application Publication
(10) Pub. No.: US 2024/0202196 A1
(43) Pub. Date: Jun. 20, 2024

(54) METHODS AND SYSTEMS THAT GENERATE COMPONENT QUANTITIES FOR SYSTEM CONFIGURATIONS

(71) Applicant: VMware LLC, Palo Alto, CA (US)

(72) Inventor: Ajitesh Gupta, Palo Alto, CA (US)

(73) Assignee: VMware LLC, Palo Alto, CA (US)

(21) Appl. No.: 18/082,308

(22) Filed: Dec. 15, 2022

(51) Int. Cl. G06F 16/2455; G06F 16/2453

(52) U.S. Cl. CPC G06F 16/24554; G06F 16/2454

(57) ABSTRACT

The current document is directed to methods and systems that generate lists of component types and quantities needed for system installations based on parameter values that characterize the system, environment, and application domain, referred to as “input values.” An implementation of a private-5G-network component-type-and-quantity-determination system is disclosed. An initial model used to generate component types and quantities is generated from information acquired from various information sources, including system vendors, designers, and/or administrators. The initial model is used to generate lists of component types and quantities on behalf of requesting entities during an initial period of system operation. Over time, as the final types and quantities of components used for particular installations are determined and reported back to the system, the system uses these reported results to refine the initial model, generate more specific models for particular types or classes of system installations and to refine the more specific models.

### TECHNICAL FIELD

The current document is directed to methods and systems that generate lists of component quantities for system installations and, in particular, to methods and systems that generate component quantities for private 5G-Network configurations.

### BACKGROUND

Cellular networks provide the basis for modern communications. Cellular networks interconnect, via radio-frequency electromagnetic signals, user devices, such as smart phones, to one another and to computer-implemented core functionalities, the public switched telephone network (“PSTN”), and the Internet. Cellular networks have continuously evolved, from the first-generation (“1G”) cellular networks launched in 1979 to the currently prevalent fourth-generation (“4G”) cellular networks that provide communications throughout the world. The 4G cellular networks are currently evolving towards the fifth-generation (“5G”) cellular-network standard that provides increased data-download speeds, higher bandwidths obtained, in part, by using additional frequency ranges, and extension of local-area networking and computational services closer to base stations along with increased use of cloud-computing-implemented back-end services. In addition, 5G cellular networks are designed to support large numbers of additional types of user devices, systems, and applications, including Internet-of-things (“IoT”) devices used in manufacturing and robotics, remote sensors, autonomous vehicles, and many other types of applications 5G cellular networks are also designed to provide for various different types of private 5G networks for use in offices, manufacturing facilities, and other local environments that need high-bandwidth radio-frequency communications for interconnecting many different types of devices and system-components.

An important step in designing, configuring, and installing complex systems, including private 5G-networks, is to determine the quantities of various system components that will be needed. A private 5G-network installation, for example, comprises many different types of components, with the types of components and the quantities of components of each type dependent on many different variables or parameters, referred to as “dimensions.” Currently, the types and quantities of various different types of private 5G-network components are generally determined by a small number of industry experts. The determination of the types and quantities of components for private 5G networks can be a highly subjective, non-standardized, and time-consuming process. When this determination does not produce accurate estimations of the types and quantities of components needed for private 5G-network installations, the cost and development times for private 5G networks can be significantly and deleteriously impacted. For this reason, those who own and manage the many different local environments for which private 5G networks need to be designed, implemented, and configured, as well as vendors of 5G-network components and private-5G-network-system installers, have recognized the desirability of better methods to determine the types and quantities of private-5G-network components needed for particular installations. Similarly, efficient methods for estimating the types and quantities of system components for many other types of systems are desired by designers, users, and administrators of many other types of systems and environments in which such systems are installed.

### SUMMARY

The current document is directed to methods and systems that generate lists of component types and quantities needed for system installations based on parameter values that characterize the system, environment, and application domain, referred to as “input values.” An implementation of a private-5G-network component-type-and-quantity-determination system is disclosed. An initial model used to generate component types and quantities is generated from information acquired from various information sources, including system vendors, designers, and/or administrators. The initial model is used to generate lists of component types and quantities on behalf of requesting entities during an initial period of system operation. Over time, as the final types and quantities of components used for particular installations are determined and reported back to the system, the system uses these reported results to refine the initial model, generate more specific models for particular types or classes of system installations and to refine the more specific models.

### BRIEF DESCRIPTION OF THE DRAWINGS

FIG. 1 provides a general architectural diagram for various types of computers.

FIG. 2 illustrates an Internet-connected distributed computer system.

FIG. 3 illustrates cloud computing. In the recently developed cloud-computing paradigm, computing cycles and data-storage facilities are provided to organizations and individuals by cloud-computing providers.

FIG. 4 illustrates generalized hardware and software components of a general-purpose computer system, such as a general-purpose computer system having an architecture similar to that shown in FIG. 1.

FIGS. 5A-B illustrate two types of virtual machine and virtual-machine execution environments.

FIG. 6 illustrates several application domains of private 5G networks.

FIGS. 7A-B illustrates certain of the front-end components of a private 5G network.

FIG. 8 illustrates some of the major components of the mobile core.

FIGS. 9A-B illustrate the functionality provided by the currently disclosed methods and systems.

FIGS. 10A-B illustrate the input parameters corresponding to the input vector (904 in FIG. 9A) and their quantized values.

FIG. 11 illustrates a model partition.

FIG. 12 illustrates partitioning of a model partition, such as the model partition shown in FIG. 11.

FIG. 13 illustrates a pTree data structure used for identifying a model partition corresponding to a set of input values.

FIG. 14 illustrates selection of a best sequence of final-configuration reports stored in a configuration queue for use in refining the coefficients of a component-model expression contained in one row of a model table (1136 in FIG. 11).

FIGS. 15A-E provide a simple C++ implementation of a circular configuration queue and a function which computes the best possible subsequence of queue entries for computing coefficients for a particular component, as discussed above with reference to FIG. 14.

FIG. 16 illustrates one method for determining new coefficients for the component-model expression for a component based on the component-quantity data received in final-configuration reports returned by clients to the CTQ estimator.

FIG. 17 is the first in a series of control-flow diagrams that illustrate one implementation of the currently disclosed CTQ estimator.

FIG. 18 shows an alternative form for the initial pTree data structure generated in step 1702 of FIG. 17.

FIGS. 19A-G provide control-flow diagrams that illustrate implementation of the two main handlers 1708 and 1712 called from the event loop illustrated in FIG. 17.

FIG. 20 provides a control-flow diagram for the routine “process config request” called in step 1712 of FIG. 17.

### DETAILED DESCRIPTION

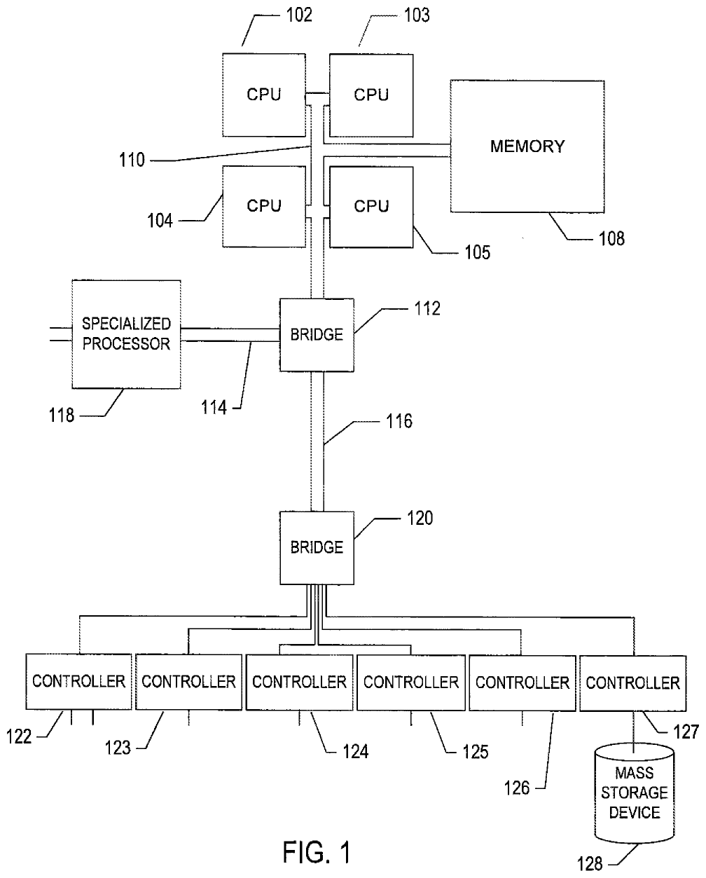

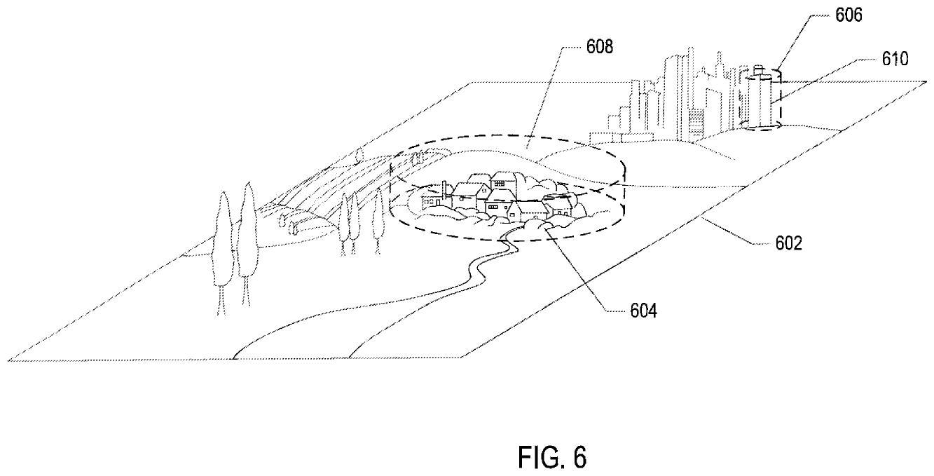

The current document is directed to methods and systems that generate component quantities for system installations. In a first subsection, below, a detailed description of computer hardware, complex computational systems, and virtualization is provided with reference to FIGS. 1-5B. In a second subsection, the currently disclosed methods and systems are discussed with reference to FIGS. 6-20.

### Computer Hardware, Complex Computational Systems, and Virtualization

The term “abstraction” is not, in any way, intended to mean or suggest an abstract idea or concept. Computational abstractions are tangible, physical interfaces that are implemented, ultimately, using physical computer hardware, data-storage devices, and communications systems. Instead, the term “abstraction” refers, in the current discussion, to a logical level of functionality encapsulated within one or more concrete, tangible, physically-implemented computer systems with defined interfaces through which electronically-encoded data is exchanged, process execution launched, and electronic services are provided. Interfaces may include graphical and textual data displayed on physical display devices as well as computer programs and routines that control physical computer processors to carry out various tasks and operations and that are invoked through electronically implemented application programming interfaces (“APIs”) and other electronically implemented interfaces. There is a tendency among those unfamiliar with modern technology and science to misinterpret the terms “abstract” and “abstraction,” when used to describe certain aspects of modern computing. For example, one frequently encounters assertions that, because a computational system is described in terms of abstractions, functional layers, and interfaces, the computational system is somehow different from a physical machine or device. Such allegations are unfounded. One only needs to disconnect a computer system or group of computer systems from their respective power supplies to appreciate the physical, machine nature of complex computer technologies. One also frequently encounters statements that characterize a computational technology as being “only software,” and thus not a machine or device. Software is essentially a sequence of encoded symbols, such as a printout of a computer program or digitally encoded computer instructions sequentially stored in a file on an optical disk or within an electromechanical mass-storage device. Software alone can do nothing. It is only when encoded computer instructions are loaded into an electronic memory within a computer system and executed on a physical processor that so-called “software implemented” functionality is provided. The digitally encoded computer instructions are an essential physical control component of processor-controlled machines and devices, no less essential and physical than a cam-shaft control system in an internal-combustion engine. Multi-cloud aggregations, cloud-computing services, virtual-machine containers and virtual machines, communications interfaces, and many of the other topics discussed below are tangible, physical components of physical, electro-optical-mechanical computer systems.

FIG. 1 provides a general architectural diagram for various types of computers. Computers that receive, process, and store event messages may be described by the general architectural diagram shown in FIG. 1, for example. The computer system contains one or multiple central processing units (“CPUs”) 102-105, one or more electronic memories 108 interconnected with the CPUs by a CPU′memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPU's and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational resources. It should be noted that computer-readable data-storage devices include optical and electromagnetic disks, electronic memories, and other physical data-storage devices. Those familiar with modern science and technology appreciate that electromagnetic radiation and propagating signals do not store data for subsequent retrieval, and can transiently “store” only a byte or less of information per mile, far less information than needed to encode even the simplest of routines.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of servers and workstations, and higher-end mainframe computers, but may also include a plethora of various types of special-purpose computing devices, including data-storage systems, communications routers, network nodes, tablet computers, and mobile telephones.

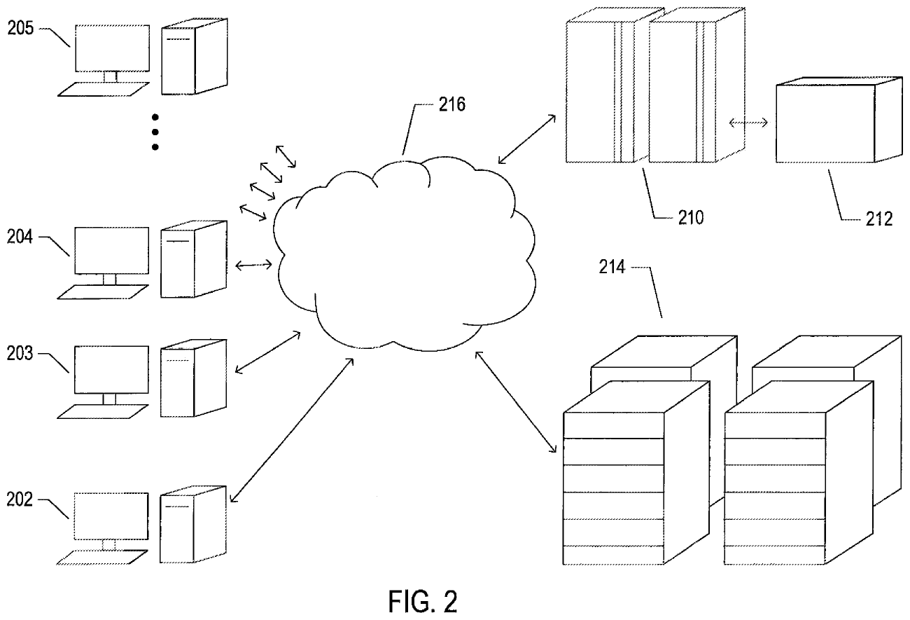

FIG. 2 illustrates an Internet-connected distributed computer system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted servers or blade servers all interconnected through various communications and networking systems that together comprise the Internet 216. Such distributed computing systems provide diverse arrays of functionalities. For example, a PC user sitting in a home office may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web servers, back-end computer systems, and data-storage systems for serving web pages to remote customers, receiving orders through the web-page interface, processing the orders, tracking completed orders, and other myriad different tasks associated with an e-commerce enterprise.

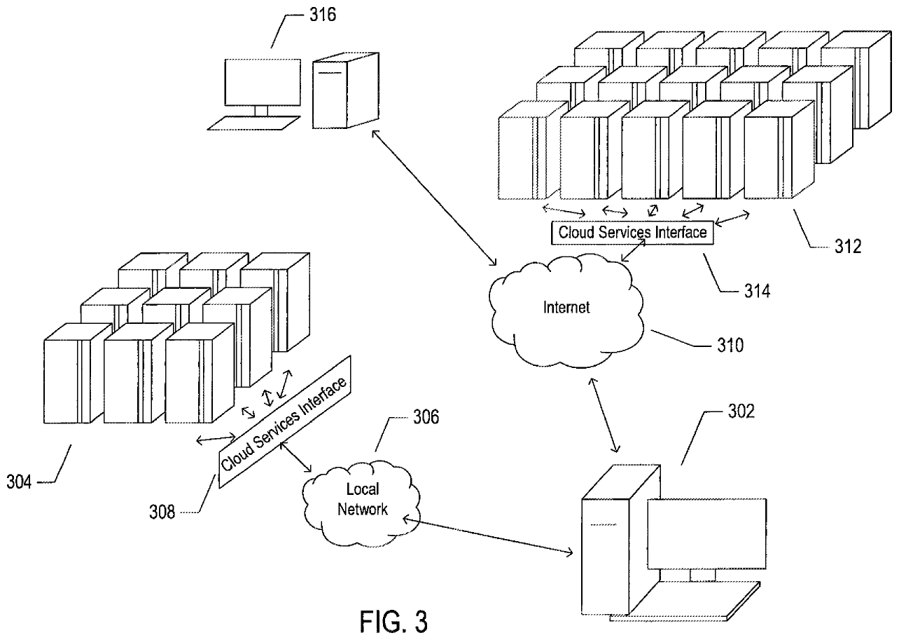

FIG. 3 illustrates cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and also accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the resources to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

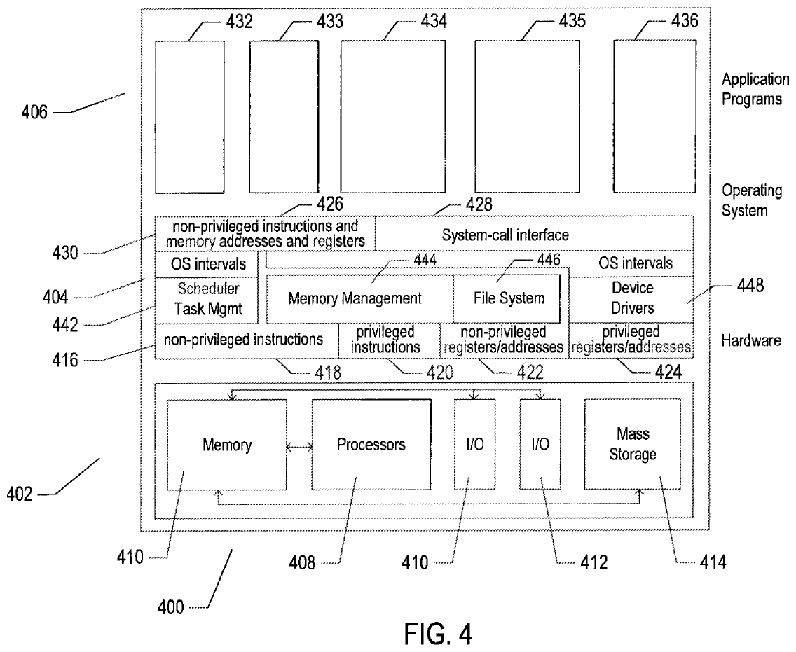

FIG. 4 illustrates generalized hardware and software components of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, various different types of input-output (“I′O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor resources and other system resources with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 436 facilitates abstraction of mass-storage-device and memory resources as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within different types of computer hardware. In many cases, popular application programs and computational systems are developed to run on only a subset of the available operating systems, and can therefore be executed within only a subset of the various different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computer system for high-availability, fault-tolerance, and load-balancing purposes. The problems are even greater in heterogeneous distributed computer systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

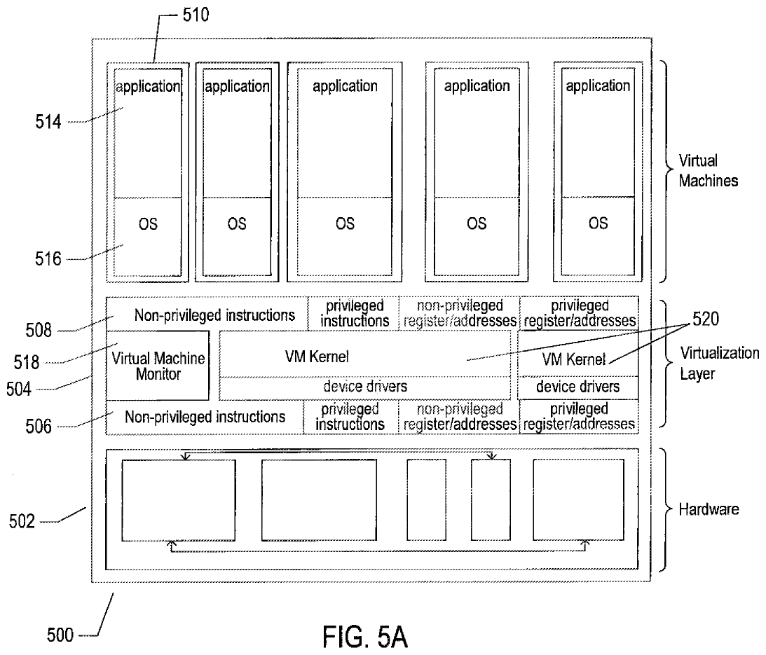

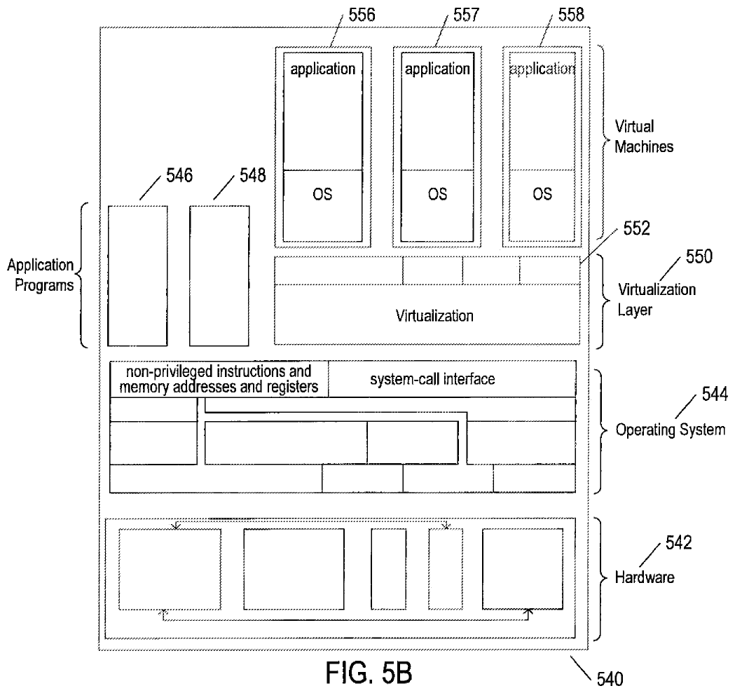

For all of these reasons, a higher level of abstraction, referred to as the “virtual machine,” has been developed and evolved to further abstract computer hardware in order to address many difficulties and challenges associated with traditional computing systems, including the compatibility issues discussed above. FIGS. 5A-B illustrate two types of virtual machine and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment illustrated in FIG. 5A features a virtualization layer 504 that interfaces through a virtualization-layer/hardware-layer interface 506, equivalent to interface 416 in FIG. 4, to the hardware. The virtualization layer provides a hardware-like interface 508 to a number of virtual machines, such as virtual machine 510, executing above the virtualization layer in a virtual-machine layer 512. Each virtual machine includes one or more application programs or other higher-level computational entities packaged together with an operating system, referred to as a “guest operating system,” such as application 514 and guest operating system 516 packaged together within virtual machine 510. Each virtual machine is thus equivalent to the operating-system layer 404 and application-program layer 406 in the general-purpose computer system shown in FIG. 4. Each guest operating system within a virtual machine interfaces to the virtualization-layer interface 508 rather than to the actual hardware interface 506. The virtualization layer partitions hardware resources into abstract virtual-hardware layers to which each guest operating system within a virtual machine interfaces. The guest operating systems within the virtual machines, in general, are unaware of the virtualization layer and operate as if they were directly accessing a true hardware interface. The virtualization layer ensures that each of the virtual machines currently executing within the virtual environment receive a fair allocation of underlying hardware resources and that all virtual machines receive sufficient resources to progress in execution. The virtualization-layer interface 508 may differ for different guest operating systems. For example, the virtualization layer is generally able to provide virtual hardware interfaces for a variety of different types of computer hardware. This allows, as one example, a virtual machine that includes a guest operating system designed for a particular computer architecture to run on hardware of a different architecture. The number of virtual machines need not be equal to the number of physical processors or even a multiple of the number of processors.

The virtualization layer includes a virtual-machine-monitor module 518 (“VMM”) that virtualizes physical processors in the hardware layer to create virtual processors on which each of the virtual machines executes. For execution efficiency, the virtualization layer attempts to allow virtual machines to directly execute non-privileged instructions and to directly access non-privileged registers and memory. However, when the guest operating system within a virtual machine accesses virtual privileged instructions, virtual privileged registers, and virtual privileged memory through the virtualization-layer interface 508, the accesses result in execution of virtualization-layer code to simulate or emulate the privileged resources. The virtualization layer additionally includes a kernel module 520 that manages memory, communications, and data-storage machine resources on behalf of executing virtual machines (“VM kernel”). The VM kernel, for example, maintains shadow page tables on each virtual machine so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer essentially schedules execution of virtual machines much like an operating system schedules execution of application programs, so that the virtual machines each execute within a complete and fully functional virtual hardware layer.

FIG. 5B illustrates a second type of virtualization. In FIG. 5B, the computer system 540 includes the same hardware layer 542 and software layer 544 as the hardware layer 402 shown in FIG. 4. Several application programs 546 and 548 are shown running in the execution environment provided by the operating system. In addition, a virtualization layer 550 is also provided, in computer 540, but, unlike the virtualization layer 504 discussed with reference to FIG. 5A, virtualization layer 550 is layered above the operating system 544, referred to as the “host OS,” and uses the operating system interface to access operating-system-provided functionality as well as the hardware. The virtualization layer 550 comprises primarily a VMM and a hardware-like interface 552, similar to hardware-like interface 508 in FIG. 5A. The virtualization-layer/hardware-layer interface 552, equivalent to interface 416 in FIG. 4, provides an execution environment for a number of virtual machines 556-558, each including one or more application programs or other higher-level computational entities packaged together with a guest operating system.

In FIGS. 5A-B, the layers are somewhat simplified for clarity of illustration. For example, portions of the virtualization layer 550 may reside within the host-operating-system kernel, such as a specialized driver incorporated into the host operating system to facilitate hardware access by the virtualization layer.

It should be noted that virtual hardware layers, virtualization layers, and guest operating systems are all physical entities that are implemented by computer instructions stored in physical data-storage devices, including electronic memories, mass-storage devices, optical disks, magnetic disks, and other such devices. The term “virtual” does not, in any way, imply that virtual hardware layers, virtualization layers, and guest operating systems are abstract or intangible. Virtual hardware layers, virtualization layers, and guest operating systems execute on physical processors of physical computer systems and control operation of the physical computer systems, including operations that alter the physical states of physical devices, including electronic memories and mass-storage devices. They are as physical and tangible as any other component of a computer since, such as power supplies, controllers, processors, busses, and data-storage devices.

### Currently Disclosed Methods and Systems

FIG. 6 illustrates several application domains of private 5G networks. A small portion of a geographical area 602 is shown in FIG. 6. The geographical area includes a small rural agricultural/manufacturing facility 604 and a tall office building 606 housing an organization, such as a software-development organization or corporate headquarters. Both the rural agricultural/manufacturing facility and the organization may have communications needs that require the device connectivity and bandwidth of a 5G network and may also have elevated security concerns that argue against using a public cellular-network. It may be the case that 5G-network access is unavailable to the agricultural manufacturing facility and the organization or it may be the case that the elevated security concerns, in addition to other concerns and requirements, dictate installation and use of a private 5G network rather than using a publicly available 5G cellular network. Therefore, as indicated by the volumes 608 and 610 that include the agricultural/manufacturing facility 604 and organization 610, shown in FIG. 6 by dashed curves and lines, both the agricultural manufacturing facility and the organization may decide to install a private 5G network to support communications in their local areas. There are numerous ways to implement a private 5G network, including installing a full set of private-5G-network components that together implement a complete, isolated private 5G network without reliance on a public 5G network, installing only a portion of the 5G-network components as privately owned components and accessing additional components of a public 5G network, or using 5G-network virtualization methods to create a private virtual 5G network within a public 5G network. In all cases, there are generally components that need to be identified and purchased in determined quantities in order to complete installation of the desired private 5G network.

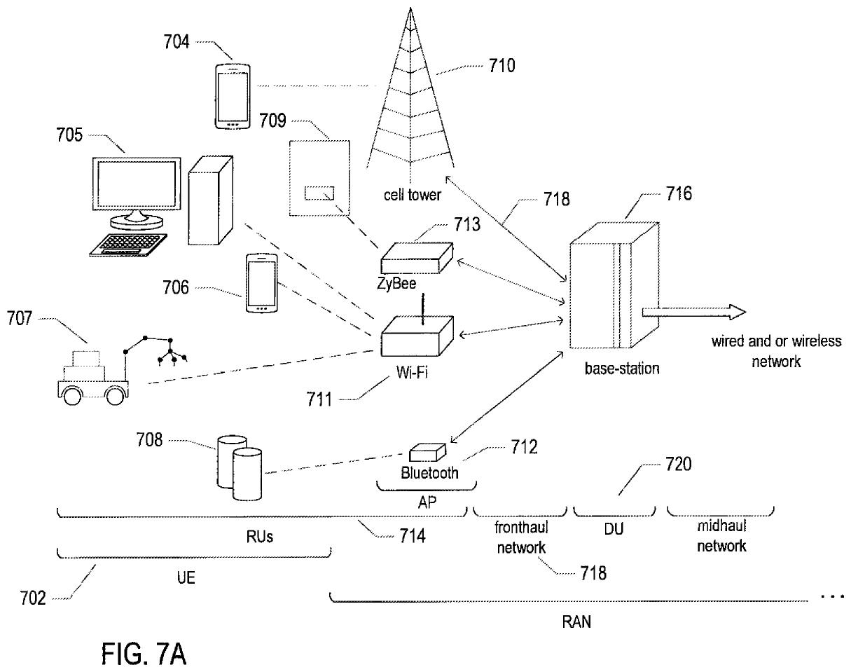

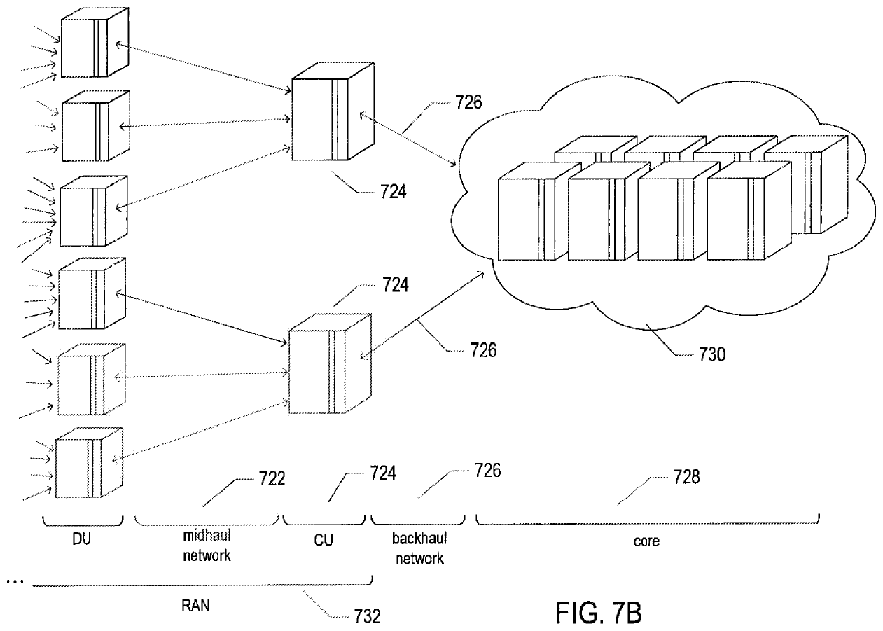

FIGS. 7A-B illustrates certain of the front-end components of a private 5G network. The lowest-level and generally most numerous components are referred to as “user equipment” (“UE”) 702. These components may include cell phones 704, computers 705 and tablets 706, manufacturing tools, devices, subsystems, and systems 707 that communicate with one another and with various types of computer-implemented controllers, various types of consumer electronics, including wireless speakers 708, and items tagged with electronic tags and labels 709 that include radio-frequency transmitters. The types and quantities of user equipment can vary tremendously with different application domains and even among different installations within a single application domain. The user equipment transmits radio-frequency signals to, and/or receives radio-frequency communications radio-frequency signals from, one or more access points (“APs”) of different types, including cell towers and other broadcast antennas 710, Wi-Fi access points 711, Bluetooth access points 712. ZigBee access points 713, and other types of radio-frequency transceivers. The user equipment and access points together comprise the radio units (“RUs”) 714 within a private 5G network. The access points communicate with a local base station 716 via one or more fronthaul networks 718. The base station, generally one of multiple base stations, include fronthaul-network controllers as well as computer-implemented network components referred to as “distributed units” (“DUs”) 720. As shown in FIG. 7B, the distributed units communicate over one or more midhaul networks 722 with one or more control units (“CUs”) 724. The midhaul networks may be either wireless or wired networks. Finally, the control units communicate over a backhaul network 726, generally a WAN or dedicated wired communications link, with a mobile core 728 generally implemented by distributed services within a cloud-computer system 730. The access points, base stations, and control units together comprise the radio access network (“RAN”) 732. Different implementations may use additional, fewer, or different classes of components. For example, in certain implementations, the control units are implemented by applications and services within a cloud-computing facility so that the backhaul network is actually a collection of virtual networks implemented on local area networks (“LANs”) and wide-area networks (“WANs”) within a distributed computer system or cloud-computing facility. For small private 5G networks, functionalities of the mobile core may be implemented within computational facilities of a single base station.

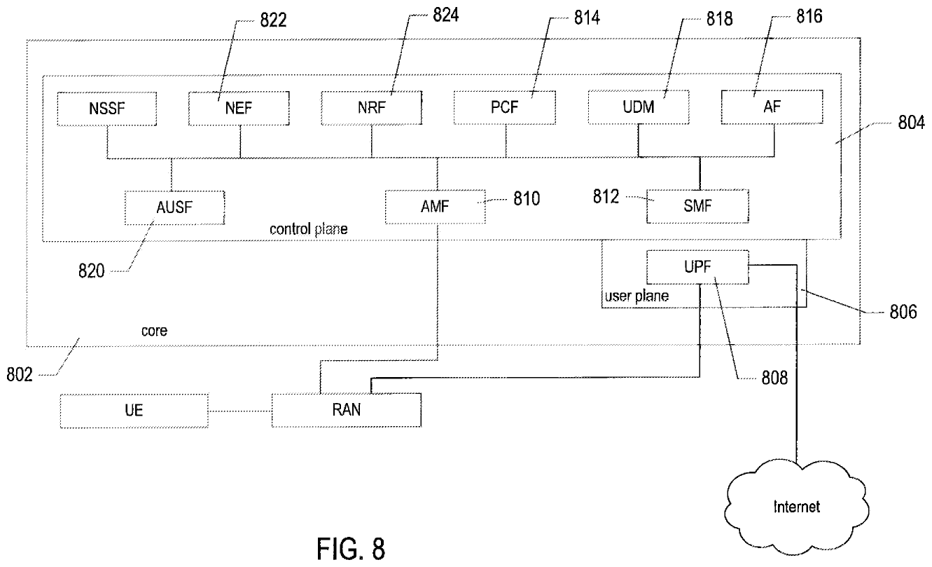

FIG. 8 illustrates some of the major components of the mobile core. The mobile core 802 is a complex system implemented by applications and service-oriented applications within a cloud-computing facility or other type of distributed computer system. The mobile core includes functionality within a control plane 804 and functionality within a user plane 806. The user plane includes a user plane function (“UPF”) 808 which transports Internet-Protocol (“IP”) data traffic back-and-forth between user equipment and the Internet. The control plane includes many different applications and services. The access and mobility management function (“AMF”) 810 represents an entry point for user-equipment connections to the 5G network. A session management function (“SMF”) 812, policy control function (“PCF”) 814, application function (“AF”) 816, and a unified data management function (“UDM”) 818 together provide a policy control framework that governs operation of the 5G network. An authentication server function (“AUSF”) 820 provides user-authentication functionality. A network exposure function (“NEF”) 822 provides a gateway to third-party services. An NF repository function (“NRF”) 824 provides a discovery service that identifies available services. A network slicing selector function (“NSSF”) implements network slicing functionality that is used to provide virtual RANs and mobile-core services. The mobile core essentially implements almost all of the core network functions, including access management authentication, data management, billing, user-device tracking and handoffs between base stations, and interconnection with the PSTN.

Thus, a private 5G network is an extremely complex system comprising many different types of components, including devices and computational components, in many different hierarchically organized levels, that span user devices, access points, base stations, control units, and the mobile core. Different types of private 5G networks may include very different sets of components that need to be purchased, incorporated, and configured within a private 5G network. Different application domains for private 5G networks may also include very different sets of components. Moreover, any particular private-5G-network installation may require particular quantities of various different types of components that differ from the required quantities and other private-5G-network installations. In addition, the transition from the currently predominant 4G networks to 5G networks is still evolving and is still underway, which is one reason that, as discussed above, determination of the types and quantities of components needed for any particular private-5G-network installation is currently carried out by specialized experts and professionals. The currently disclosed methods and systems seek to automate the task of determining the types and quantities of components needed for a particular private-5G-network installation, but can be more generally applied to determining the types and quantities of components of many different additional types of complex systems.

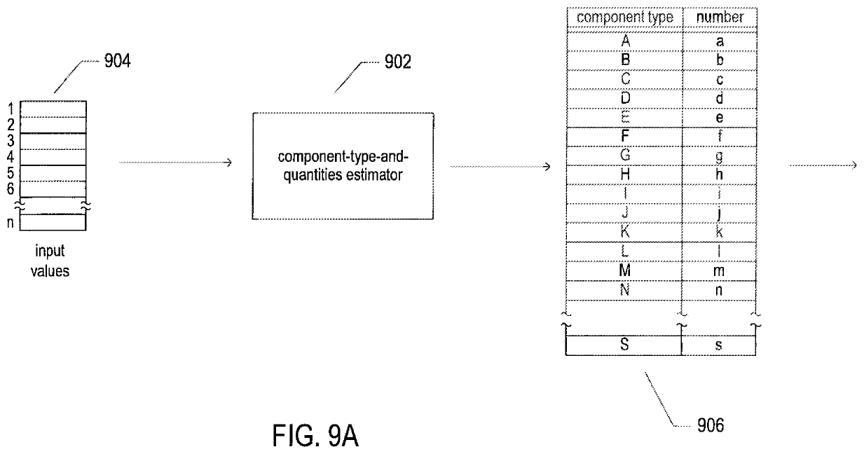

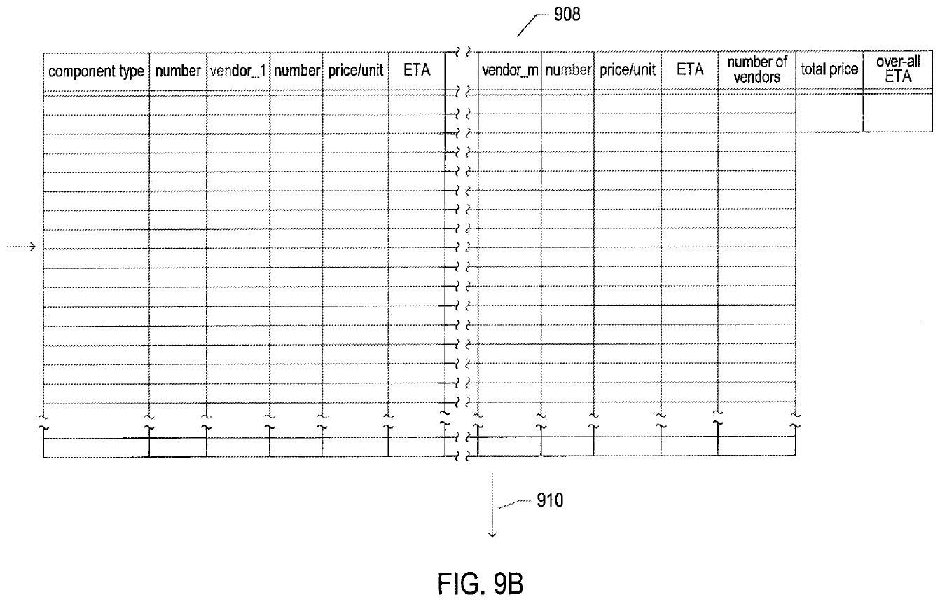

FIGS. 9A-B illustrate the functionality provided by the currently disclosed methods and systems. As discussed above, currently disclosed systems are component-types-and-quantities estimators (“CTQ estimators”) 902 that receive a list or vector 904 of input values and produce an ordered list 906 of component-type quantity pairs. In the currently disclosed implementation, the input values are included in an input-value vector, with the position of each value in the vector corresponding to the parameter for which the value is supplied. The produced list of component-type/quantity pairs may be a single vector of component quantities, with the component type associated with a quantity inferred from the position or index of the quantity in the vector. In the case of a CTQ estimator that estimates the types and quantities of components for a private 5G network, the output list 906 provides indications of the types and quantities of components needed for a private-5G-network installation characterized by the input values 904. In the disclosed implementation, component types for which the computed quantities are 0 are omitted from the output list. As shown in FIG. 9B, the output list produced by a CTQ estimator can be, in turn, provided to downstream automated systems that, as one example, produce a more detailed list of component types and quantities 908 that includes vendor information, prices, estimated times for delivery, and other information. The more detailed list of component types and quantities and then, in turn, be transmitted 910 to automated systems that order the necessary components, manage component purchases and payments, and interoperate with design, configuration, and installation applications to facilitate the design, configuration, and installation of a private 5G network.

There are many different types of input parameters corresponding to the input values provided to a CTQ estimator. In the case of a CTQ estimator for private-5G-network installations, significant parameters generally include indications of the type of private 5G network, the square footage or other indications of area of the terrain, office space, and other portions of the region to be covered by the private 5G network, the type of enterprise, facility, or organization for which the private 5G network is to be implemented, parameters and characteristics for the types of facilities requiring IoT sensors, the number of employees, which may be broken down into the number of employees within different portions of the total region of coverage, and many additional parameters and characteristics. The output list of component types and quantities is generally ordered according to the order of the different component types in a model used by the CTQ estimator for estimating the numbers of each type of component needed for a particular private-5G-network installation. As discussed below, the model is ordered so that, as the quantities of components are estimated using the model, the numbers of any components that are included in the expression or component-specific model for a particular component will have already been calculated when the quantity of that particular component is estimated.

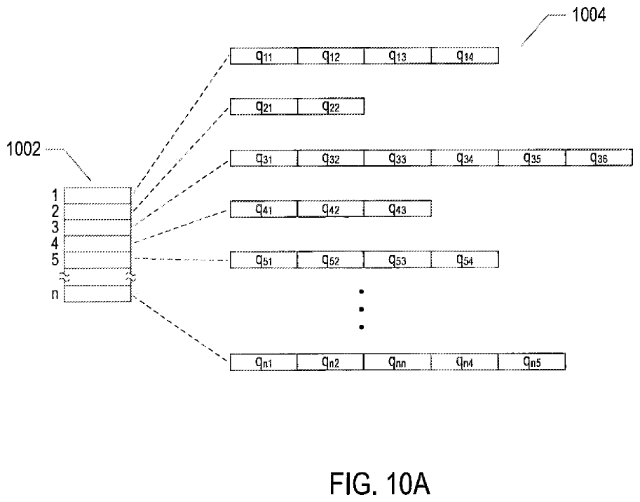

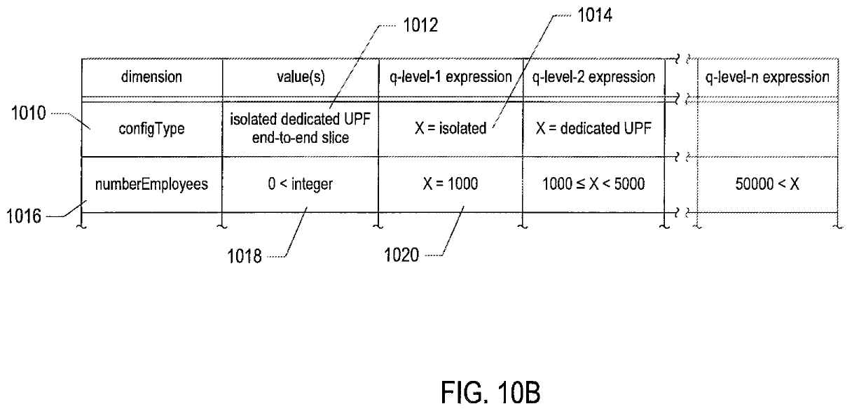

FIGS. 10A-B illustrate the input parameters corresponding to the input vector (904 in FIG. 9A) and their quantized values. As mentioned above, the elements of the input vector correspond to parameters that characterize the desired private-5G-network installation. The possible values for the parameters are quantized, for reasons that will be apparent later in the discussion. Thus, each parameter, such as the first parameter corresponding to the first vector element 1002, can have one of only a relatively small number of different quantized values, or quantization levels, such as the four quantized values 1004: q₁₁, q₁₂, q₁₃, and q₁₄. FIG. 10B shows the first two rows of a table that contains parameters, or dimensions, and the possible values for those parameters. A first parameter configType 1010 corresponds to the type of private-5G-network installation. In this example, there are three different configuration types 1012: isolated, dedicated UPF, and end-to-end slice. Each of these discrete values corresponds to a quantization level. Each quantization level, in turn, is associated with an expression that returns the Boolean value TRUE when a value for the parameter replaces the symbol “X” in the expression. These expressions are used to assign quantization levels to input parameter values. For example, when the value isolated replaces the symbol “X” in expression 1014, “X=isolated,” evaluation of the resulting expression “isolated=isolated” returns a Boolean value TRUE. A second parameter number Employees 1016 represents the total number of employees for an organization, enterprise, or facility for which the private 5G network is to be developed and installed. In this case, the parameter can have positive integer values 1018. The quantization-level-assignment expressions, such as expression 1020, are relative expressions. For example, the first quantization level is assigned to the parameter when the value of the parameter is less than 1000. Parameter values can be of various different simple and complex types, provided that expressions that evaluate to Boolean values can be constructed to assign each possible value to a quantization level. Of course, the expressions can use techniques, other than including an “X” symbol, for indicating how the expression is modified for specific values.

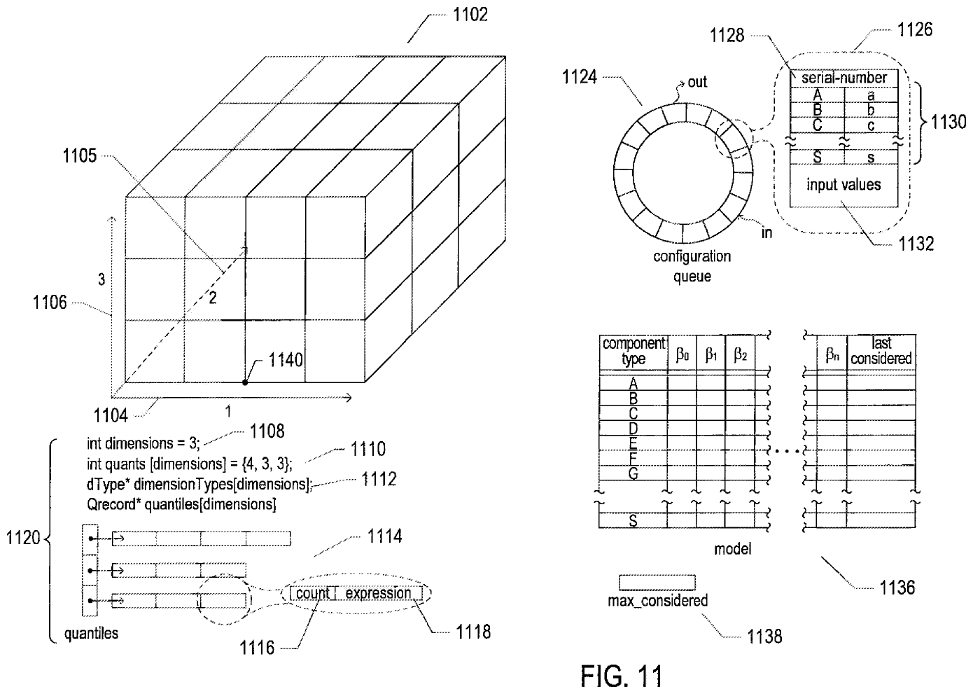

FIG. 11 illustrates a model partition. As discussed above, a CTQ estimator initially uses a model derived from information provided by vendors, system designers, and other sources of information that can be used to develop model expressions for computing the quantities of each type of component. These component-model expressions are refined as feedback is returned from those who receive output lists. The feedback is received, in the disclosed implementation, as final-configuration reports that include the types and quantities of components used in an installation along with a set of input values that characterize the installation. Over time, when a sufficient amount of feedback has been returned, the initial model may be partitioned into two different sub-model partitions, referred to as “model partitions,” that are relevant for two different classes of desired private-5G-network installations.

The initial model, or initial model partition, and the subsequently produced model partitions are each represented by the data structures shown in FIG. 11. A model partition represents a model for an input-value space or input-value subspace of the possible quantized parameter values. In the example shown in FIG. 11, there are three different parameters for which input values are provided by clients requesting component types and quantities and for which input values are provided in final-configuration reports. The input-value space is therefore three-dimensional since each parameter corresponds to a dimension. The input-value space is represented in FIG. 11 by a three-dimensional volume 1102 defined by three Cartesian axes 1104-1106. The dimensionality of the parameter-value space, 3, is stored in an integer dimensions 1108. The number of quantization levels for each dimension is stored in an array quants 1110. The data types of the quantization-level values for each dimension are stored in an array dimensionTypes 1112. Finally, the above-discussed quantization-level expressions for each value of each parameter, or dimension, along with a count of the number of received final-configuration responses that include that parameter value in the input values, are stored in a quantiles data structure 1114, which comprises an array quantiles and additional arrays pointed to by pointers, or references, contained in elements of the array quantiles. The elements of the additional arrays are Qrecords, each Qrecord including a count field 1116 and an expression field 1118. Thus, the above-discussed data values and data structures 1122 together completely describe the input-parameter-value space or subspace 1102 represented by the partition.

The model partition additionally includes a configuration queue 1124 which stores returned final-configuration reports that are subsequently used to refine the model, discussed below, and to partition the model into sub-model partitions. The configuration queue is a circular queue, with old entries in the queue overwritten by new, incoming entries so that the configuration queue stores a sliding window of the most recently received final-configuration reports. Each entry in the configuration queue, as shown in inset 1126, stores a timestamp or serial number 1128, a list of the component types and quantities in the final configuration 1130, and an input-value vector 1132 containing the parameter values that characterize the installed private 5G network. The received final-configuration reports are each associated with a unique timestamp or serial number which monotonically increases for each new received final configuration. The model partition also includes the actual model 1136 used for computing the types and quantities of components for a private 5G network characterized by a vector of input values. The model is shown, in FIG. 11, as a table. Each row in the table corresponds to a different component type. The columns of the table, which represent fields in the rows, include values for the coefficients of a single-variate or multivariate polynomial that represents the component model for the component represented by the row, referred to below as a “component-model expression.” The component-model expressions are discussed below. Each row also includes a last_considered field that includes a timestamp associated with the most recently received final configuration used to compute the coefficients for the component model represented by the row. An integer max_considered 1138 contains the largest or most recent timestamp contained in the last_considered column of the model 1136.

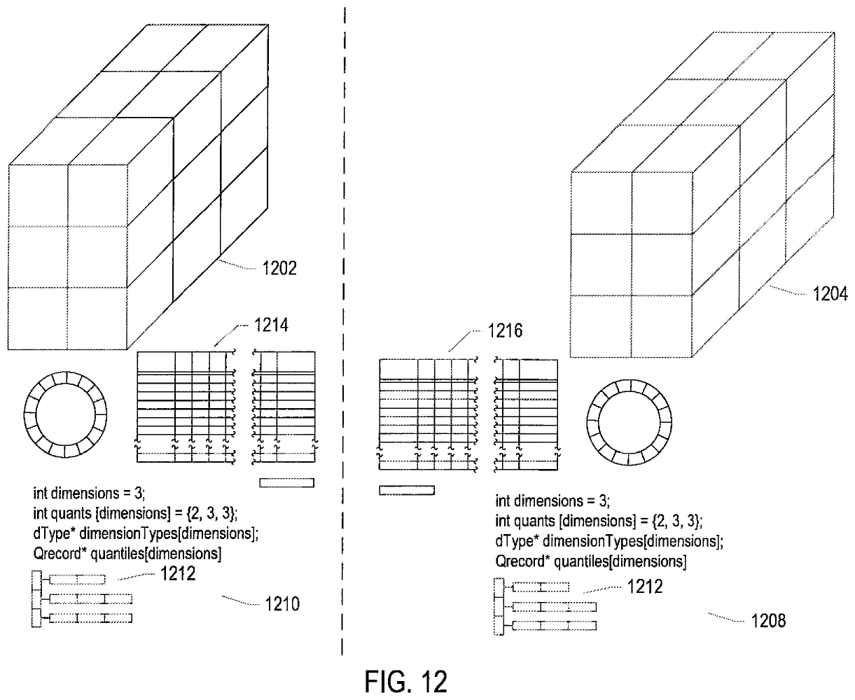

FIG. 12 illustrates partitioning of a model partition, such as the model partition shown in FIG. 11. The partitioning illustrated in FIG. 12 occurs because a sufficient number of final-configuration reports have been received and because the received final-configuration reports include values for the first parameter that are fairly evenly distributed between the first two-quantization-level and second two-quantization-level portions of the array referenced by the first entry in the array quantiles. Thus, the parameter-value space 1102 can be partitioned by dividing the parameter-value space by a vertical plane centered at the midpoint of the first axis 1140. This results in a first partition 1202 of the parameter-value space 1102 and a second partition 1204 of the parameter-value space 1102. The model partition shown in FIG. 11 is then divided into two sub-model partitions 1206 and 1208 associated with the first partition 1202 of the parameter-value space 1102 and the second partition 1204 of the parameter-value space 1102, respectively. The arrays 1210 and 1212 referenced by the first element in the quantile arrays in these two partitions now have two elements instead of the four elements in the array referenced by the first element of the quantiles array in the model partition shown in FIG. 11. When component quantities are requested for a private-5G-network installation for which the input value for the first parameter falls into the quantization levels in array 1210, the component quantities are computed using the model 1214 in model partition 1206 while when component quantities are requested for a private-5G-network installation for which the input value for the first parameter falls into the quantization levels in array 1212, the component quantities are computed using the model 1216 in model partition 1208. In other words, the more feedback received by a CTQ estimator, the finer the model granularity that can be generated and used by the CTQ estimator.

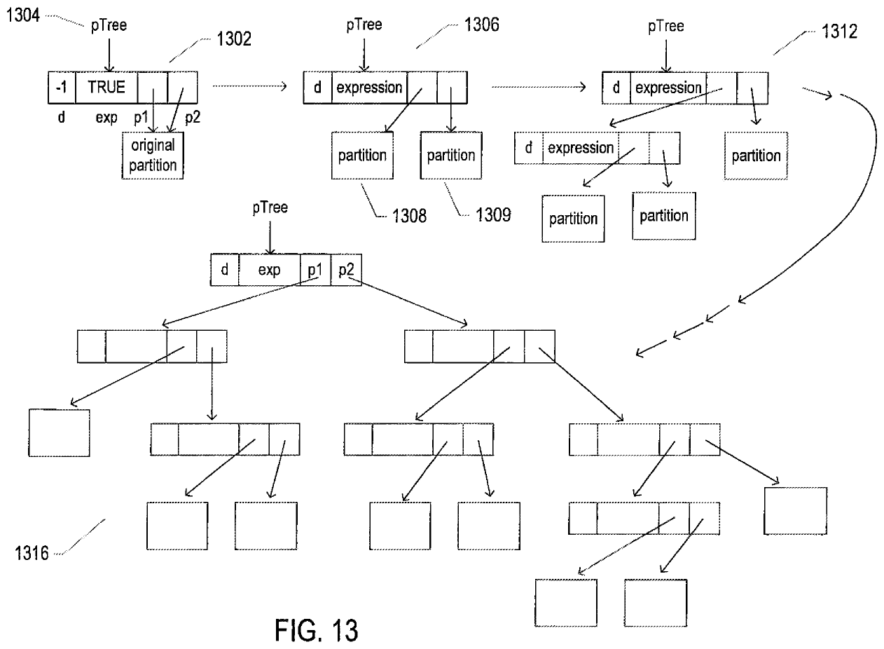

FIG. 13 illustrates a pTree data structure used for identifying a model partition corresponding to a set of input values. The pTree data structure is an acyclic graph, or tree. It is initialized, in certain implementations, to contain a single root node 1302 referenced by a pointer pTree 1304. Each node, such as node 1302, includes four fields: (1) d, which contains a numeric indication of a dimension or parameter; (2) exp, which contains an expression that evaluates to a Boolean value when the symbol “X” in the expression is replaced by a value of the parameter indicated by the d field; (3) p1 which contains a reference to either another node or to a model partition: and (4) p2, which contains a reference to either another node or to a model partition. During a traversal of the pTree data structure, a parameter value from a set of input values is used to evaluate the expression in a currently considered node and the traversal then continues to the node or partition pointed to by the reference in field p2 when the expression evaluates to TRUE and otherwise continues to the node or partition pointed by the reference in field p1. As more final-configuration reports are received by the CTQ estimator and as partitions are subdivided to create sub-model partitions for parameter-value-space sub spaces, the pTree continues to grow downward from the root. All the leaf nodes of the tree are model-partition data structures. The pTree data structure is traversed from the root node to a leaf node using a set of input values in order to select the appropriate model partition with which to compute component types and quantities for a desired private-5G-network installation represented by the input values. In the initial state of the pTree data structure, which contains only a single node 1302, both the p1 and p2 fields of the single note point to the same original model developed using vendor and developer information. After the first partition of the original model, the pTree data structure has the form 1306, with two leaf nodes 1308-1309 containing the two sub-model partitions generated from the original model. A subsequent partition of model partition 1308 produces a pTree data structure of the form 1312. After additional partitions of model partitions, the pTree data structure may have the form similar to that of data structure 1316 shown in FIG. 13. The pTree data structure is a comprehensive data structure that both contains all of the model partitions that represent classes of system installations as well as a searchable data structure for finding particular model partitions.

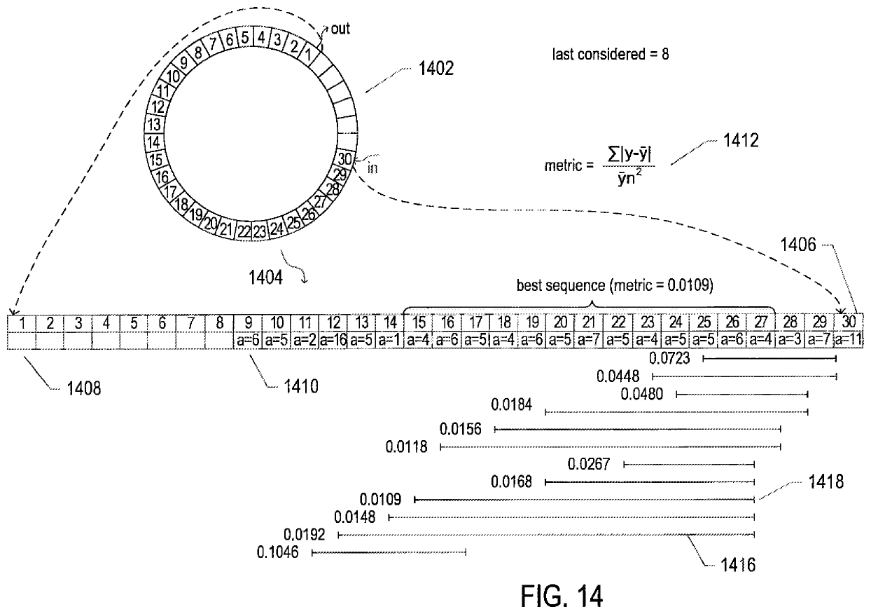

FIG. 14 illustrates selection of a best sequence of final-configuration reports stored in a configuration queue for use in refining the coefficients of a component-model expression contained in one row of a model table (1136 in FIG. 11). In this example, there are 30 final-configuration-report entries in the configuration queue 1402, each entry shown, in FIG. 14, with an integer representing the timestamp or serial number of the entry. The contents of the configuration queue are linearized 1404 to facilitate discussion of selection of a best sequence of entries. For ease of illustration, each entry in the linearized version of the set of queue entries includes both a timestamp and the final quantity of component a, rather than a full final-configuration report. In general, a sequence of configuration-queue entries needs to have at least some threshold number of entries in order for coefficients to be calculated from them. Furthermore, only those entries starting from the most recent entry in the configuration queue 1406 and progressing backward towards the least recent entry 1408 with timestamps greater than the timestamp contained in the last_considered field of the row in the model table for the component, for which coefficients are to be calculated, are candidates for use in coefficient calculation. In the example shown in FIG. 14, entry 1410 is the least recently received entry of the timestamp greater than the timestamp 8 contained in the last_considered field of the row in the model table for component a. The task illustrated in FIG. 14 is to identify a subsequence or sequence of configuration-queue entries best suited for use in computing new coefficients for component a. In one approach to solving this task, each possible subsequence, including the full sequence, of entries within the sequence of entries beginning with entry 1406 and extending down to entry 1410 is evaluated by computing a numeric metric for the subsequence. One approach to computing a numeric metric is indicated by expression 1412, where y represents one of the final-configuration quantities for component a, y̅ represents the average reported component quantity for component a, and n represents the number of configuration-queue entries in the subsequence. This metric approaches 0 for the best subsequence. It favors longer subsequences over shorter subsequences and favors subsequences with lower variances over subsequences with higher variances. In the lower portion of FIG. 14, a number of horizontal line segments, such as horizontal line segment 1416, represent some of the possible subsequences within the considered sequence of configuration-queue entries starting from entry 1406 and ending with entry 1410. The computed value for the metric is shown to the left side of each horizontal line segment. Line segment 1418 has the lowest metric value and, in fact, has the lowest metric value of all possible subsequences of the considered sequence, including the full sequence.

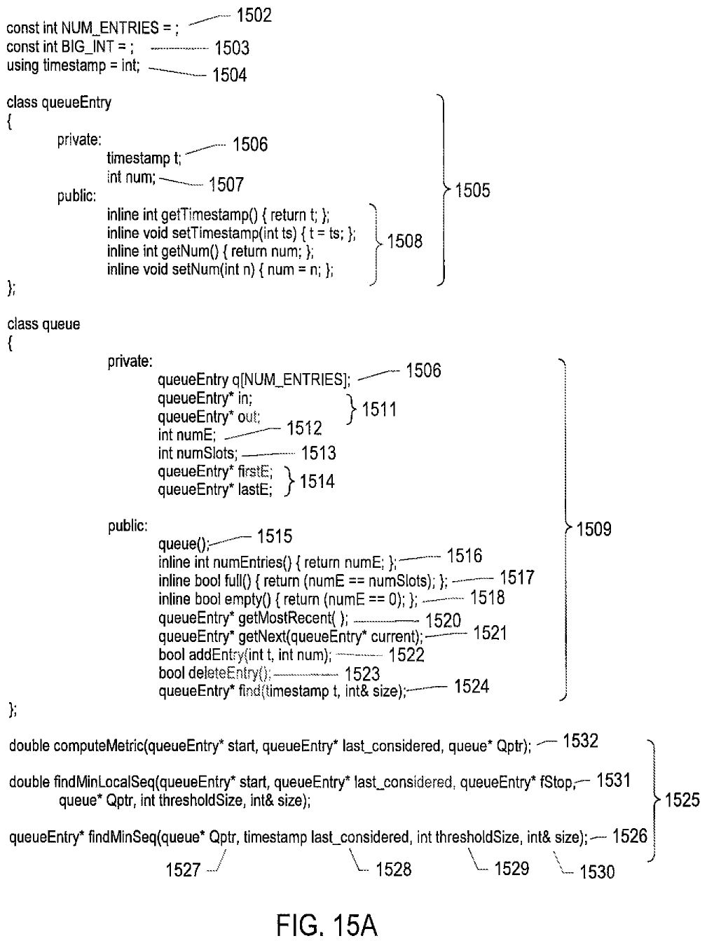

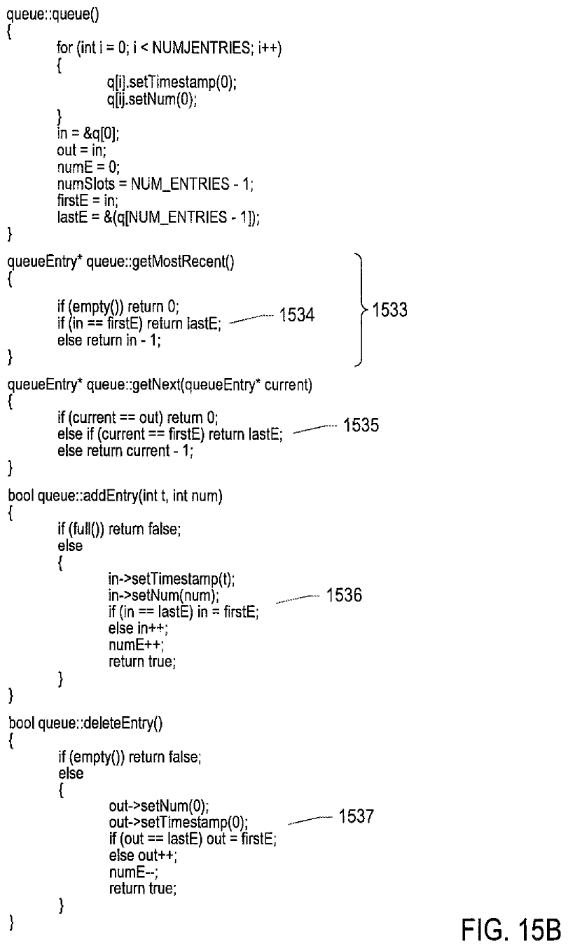

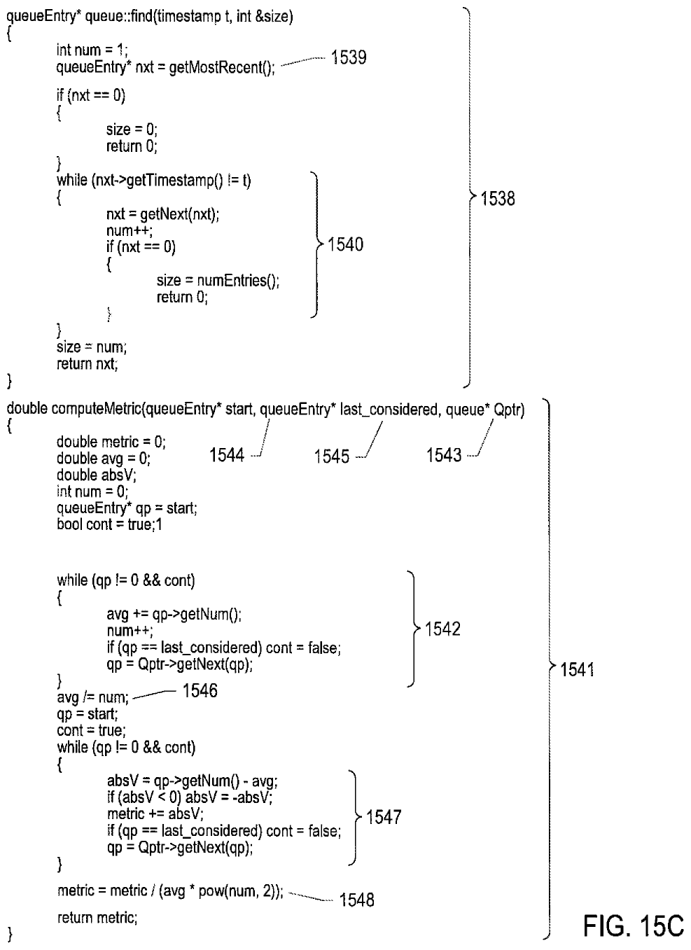

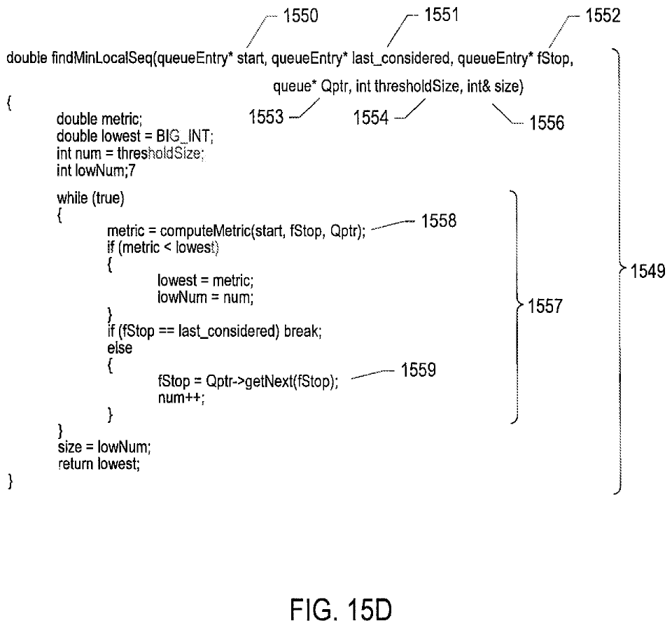

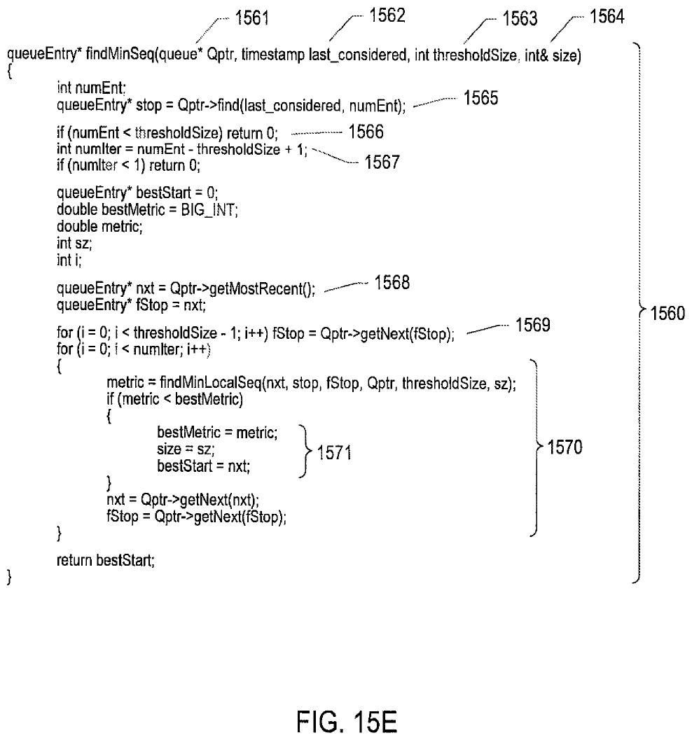

FIGS. 15A-F provide a simple C++ implementation of a circular configuration queue and a function which computes the best possible subsequence of queue entries for computing coefficients for a particular component, as discussed above with reference to FIG. 14. In this simple implementation, the queue entries contain only a timestamp and the quantity for a single component, as in the example shown in FIG. 14. The configuration queues used in the model partitions of a CTQ estimator, as discussed above with reference to FIG. 11, contain entries that include a timestamp, input values, as well as quantities for all of the various different components that may be needed for a private-5G-network installation.

FIG. 15A includes various classes and function declarations for the simple C++ implementation. A constant NUM ENTRIES 1502 is set to a numeric value to indicate the maximum total number of entries in the circular queue. The constant BIG INT 1503 is set to a large integer. A timestamp data type 1504 is declared for use in queue entries. A class queue Entry for queue entries is next declared 1505. Each queue entry includes a timestamp t 1506 and a component quantity num 1507 that together represent an abbreviated final configuration reported back to the CTQ estimator and stored in a circular queue. The class queue Entry includes member functions 1508 for retrieving and setting the timestamp and component-quantity data members. A class queue is next declared 1509. Data members of the class queue include an array q of queue Entry instances 1510, in and out pointers 1511 that reference a next entry in which to add a final-configuration report and the least recently stored entry that is deleted by a call to the member function deleteEntry, respectively. The integer numE 1512 stores the number of final-configuration reports currently stored in the queue. The integer numSlots 1513 stores the total number of entries that can be stored in the queue. Pointers firstE and lastE 1514 reference the first and last entries in the queueEntry array q. The member functions for the class queue include: (1) a constructor 1515; (2) numEntries 1516, which returns the number of final-configuration reports currently stored in the queue; (3) full 1517, which returns a Boolean value indicating whether or not the queue is full; (4) empty 1518, which returns a Boolean value indicating whether or not the queue is currently empty; (5) getMostRecent 1520, which returns a reference to the most recently stored entry in the queue; (6) getNext 1521, which returns an entry preceding the entry referenced by the argument current, in timestamp order; (7) addEntry 1522, which adds an entry into the circular queue; (8) delete Entry 1523, which deletes the least recently added entry from the circular queue; and (9) find 1524, which returns a pointer to a queue entry containing the timestamp supplied as the first argument and the number of entries contained in the queue that include the queue entry and all queue entries with larger timestamps. Finally, three functions 1525 are declared. The function findMinSeq 1526 finds the best subsequence of queue entries from which to generate new coefficients for the component-model expression for the component in the example, as discussed above with reference to FIG. 14. This function receives, as arguments, a pointer to a circular queue 1527, the timestamp value for the most recently received queue entry that was used to generate the last set of coefficients 1528 for the component being considered, a threshold size for the subsequence 1529, and the size of the best subsequence identified by the function findMinSeq 1530. The function findMinLocalSeq 1531 is called by the function findMinSeq to identify the best subsequence of queue entries within a subsequence of queue entries that begins with the queue entry referenced by the argument start and that ends with the last usable queue entry in the queue. The function computeMetric 1532 is called by the function findMinLocalSeq to compute the metric (1412 in FIG. 14) for a subsequence of queue entries that begins with the queue entry referenced by the argument start.

FIG. 15B shows implementations of non-inline member functions of the class queue. These implementations illustrate how the linear array q is logically converted into a circular queue. For example, in the implementation of the routine getMostRecent 1533, when the pointer member in points to the first entry in the array y, a reference to the last entry is returned 1534, which essentially wraps around the beginning of the array q to the end of the array q. Similar wrapping operations can be found on lines 1535 team 36 and 1537. The function implementation 1538 shown in FIG. 15C implements the queue member function find. The local pointer variable nxt is initialized to point to the queue entry with the most recent timestamp 1539 and is then iteratively set to queue entries with smaller timestamps in the while-loop 1540 until the local variable nxt references the least recently entered queue entry that can be considered for generating new coefficients.

An implementation of the function computeMetric 1541 is shown in the lower portion of FIG. 15C. This function computes the metric 1412 discussed above with reference to FIG. 14. In a first while-loop 1542, the sum of the component quantities contained in the queue entries in the queue referenced by the third argument Qptr 1543, starting with the queue entry referenced by the first argument start 1544 and continuing with the preceding queue entries down to the queue entry referenced by argument last_considered 1545, is computed. The average component quantity is then computed 1546 by dividing the sum of component quantities by the number of queue entries from which the sum was computed. In a second while-loop 1547, the sum of the absolute values of the differences between the component quantities and the average component quantity, which is the numerator of the metric expression 1412, is computed. Finally, the metric value is computed as the numerator divided by the denominator 1548 of expression 1412. This is a rather brute-force method for computing the metric value, but simple brute-force implementations are acceptable in the implementation of CTQ estimators since the rate at which final-configuration reports are received from clients is generally quite low, on the order of, at most, a few tens of final-configuration reports per day and often far less. Even when the rate at which final-configuration reports are received exceeds this lower rate by several orders of magnitude, the computational overhead associated with using brute-force methods is of no significance and is well offset by the simplicity of implementation versus the far more complex implementations needed to more efficiently compute metric values.

FIG. 15D shows an implementation 1549 of the function findMinLocalSeq. This function finds the best subsequence of queue entries in a sequence of queue entries that begin with the queue entry referenced by the first argument start 1550 and ends with the queue entry referenced by the second argument last_considered 1551. Because a threshold number of queue entries is needed for coefficient computation, the third argument fStop 1552 points to the first queue entry preceding the starting queue entry 1550 that constitutes a subsequence of the required threshold length. The fourth argument queue references the circular queue 1553, the fifth argument 1554 indicates the threshold size of a subsequence, and the final argument 1556 is a reference used to return the size of the best subsequence found by the function findMinlocalSeq. In the while-loop 1557, metric values for subsequences of increasing length are computed 1558 by iteratively setting fStop to the next most recently received queue entry in line 1559.

Finally, FIG. 15E provides an implementation 1560 of the function findMinSeq. The first argument Qptr 1561 references a circular queue. The second argument last_considered 1562 is the timestamp of the most recently received queue entry that was previously used in computing coefficients for the component in the example of FIGS. 15A-F. The third argument thresholdSize 1563 is the smallest sequence of queue entries that can be used for coefficient computation. The final argument 1564 is a reference to an integer that stores the size of the identified best subsequence of queue entries from which to compute coefficients for the component-model expression for the component. This function returns a null pointer if an acceptable subsequence cannot be found. The queue member function find is called to set the local variable stop to the queue entry corresponding to the least most recently received queue entry that can be used for coefficient computation 1565. When the number of entries in the sequence of queue entries that begin with the most recently received queue entry in the queue and extends down to the queue entry referenced by local variable stop is less than the threshold size, the function findMinSeq returns a null pointer 1566. The local variable numIter is set to the number of possible iterations of a for-loop discussed below 1567. The local variable nxt is set to reference the most recently received queue entry in the queue 1568. The local variable fStop is set to the queue entry that defines a subsequence of the threshold size starting from the queue entry referenced by local variable nxt 1569. In the for-loop 1570, successively shorter sequences of queue entries that begin with the queue entry referenced by local variable nxt and end with the queue entry referenced by local variable stop are considered. For each considered sequence of queue entries, the function findMinLocalSeq is called to find the best subsequence within the considered sequence of queue entries. The subsequence with the best computed metric is stored in local variables bestStart and size and the best computed metric is stored in local variable best Metric 1571.

The implementation of the function findMinSeq thus also represents a brute-force method that considers each possible subsequence of queue entries that are candidates for use in computing coefficients for the component-model expression for the component in the example of FIGS. 15A-E. Again, in an actual implementation of a CTQ estimator, queue entries contain quantities for each possible component in a private-5G-network installation, so that the function findMinSeq would contain an additional argument indicating which component is currently being considered and the function findMinSeq would be called for each different type of component when determining whether or not to recomputes coefficients based on the most recently received queue entries in a circular queue. As explained above, the simplicity of implementing brute-force methods offsets the computational inefficiencies of such methods. More efficient methods would use complex logic, similar to that used for computing running averages, to avoid computing the metric separately for each considered subsequence, but such complexity is unwarranted since the rate at which final-configuration reports are received by a CTQ estimator is generally quite low.

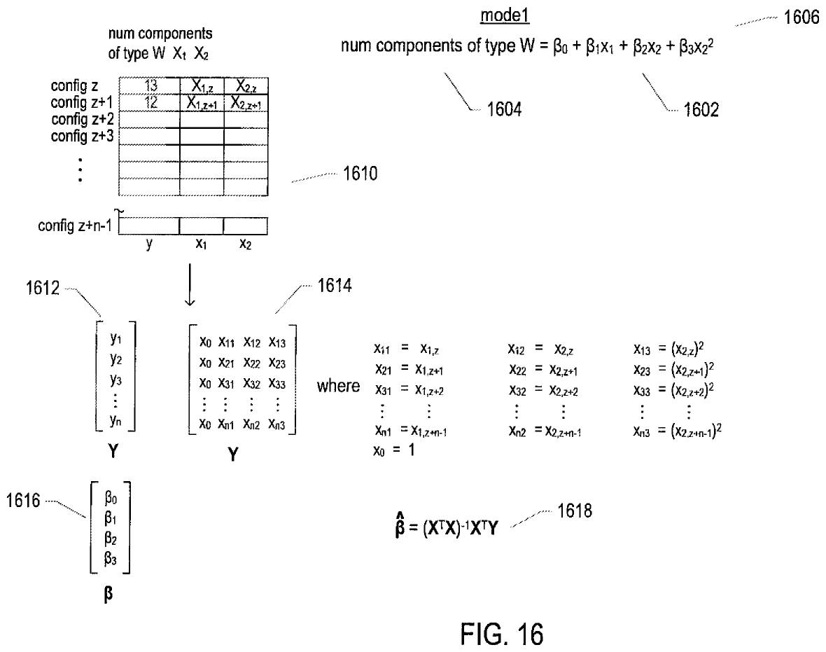

FIG. 16 illustrates one method for determining new coefficients for the component-model expression for a component based on the component-quantity data received in final-configuration reports returned by clients to the CTQ estimator. A general expression used for component-model expressions in the currently disclosed implementation is a single-variable or multivariate polynomial β₀, β₁, β₂ . . . βₙ, where n≥2, the variables x₁, x₂, . . . xₙ are computed values from one or more underlying parameter values and/or from estimated quantities of other components, and the coefficients β₀, β₁, β₂, β₃ . . . βₙ are initially computed from vendor-supplied data and other information and intermittently refined by the process discussed below. Component-model expressions are initially determined from various information sources, as are the initial coefficient values for each of the component-model expressions. The component-model expressions are stored along with the pTree data structure, including the model partitions, to represent all of the data needed for estimating needed quantities of the various different types of components for installation of a private 5G network. The ordering of the component models within a model is designed so that the quantities of any other components that appear as variables in a particular component model are estimated by component models that occur earlier in the list of component models that forms the model.

In the currently described implementation, the overall forms of the component-model expressions are not altered during refinement and model partitioning operations based on received final-configuration reports. In alternative implementations, the forms of the component-model expressions may be altered in order to produce component-model expressions that better fit the additional information provided in final-configuration reports submitted to the CTQ estimator by clients. At the top of FIG. 16, an example component-model expression 1606 is shown. The number of components of component type W 1604 is estimated from component-model-expression polynomial 1606, where x₁ is a first input parameter and x₂ is a second input parameter. Polynomial 1606 is therefore a function of two input parameters or values. Polynomial 1606 thus conforms to the above discussed general expression where n=3 and x₁=x₁, x₂=x₂, and x₃=x₂². A table 1610 illustrates the data used for computing new coefficients for the component of type W. Each row in the table represents the data extracted from a particular final configuration recorded by a client. The final-configuration reports are associated with numerical labels z, z+1, z+2, . . . z=+n−1, where n is the total number of final-configuration reports or data points. The first column of the table includes the values y, which are the reported quantities of the component of type W in each final configuration. The second column contains the values of input value x₁ in each final configuration and the third column contains the values of input value x₂ in each final configuration. The data in table 1610, along with the component-model expression 1606, allows for generation of the vector Y 1612, the matrix X 1614, and the vector β 1616 as indicated by the expressions in the middle of FIG. 16. The values for the coefficients in vector β that minimize the sum of the squares of the differences between the observed component-quantity values in the vector Y and the quantities computed from the component-model expression 1606 are found via the matrix equation 1618. This method of determining coefficients is referred to as the least-squares methods and is commonly used in data analysis, statistics, engineering, and quantitative sciences. Of course, successful determination of coefficients depends on the invertibility of the matrix X^{T}X, but in special cases where the matrix is not invertible, it is simply not possible to generate new coefficients from the data at hand and thus the initial coefficients are not changed in view of the currently available data. In the current discussion, it is assumed that the matrix is invertible.

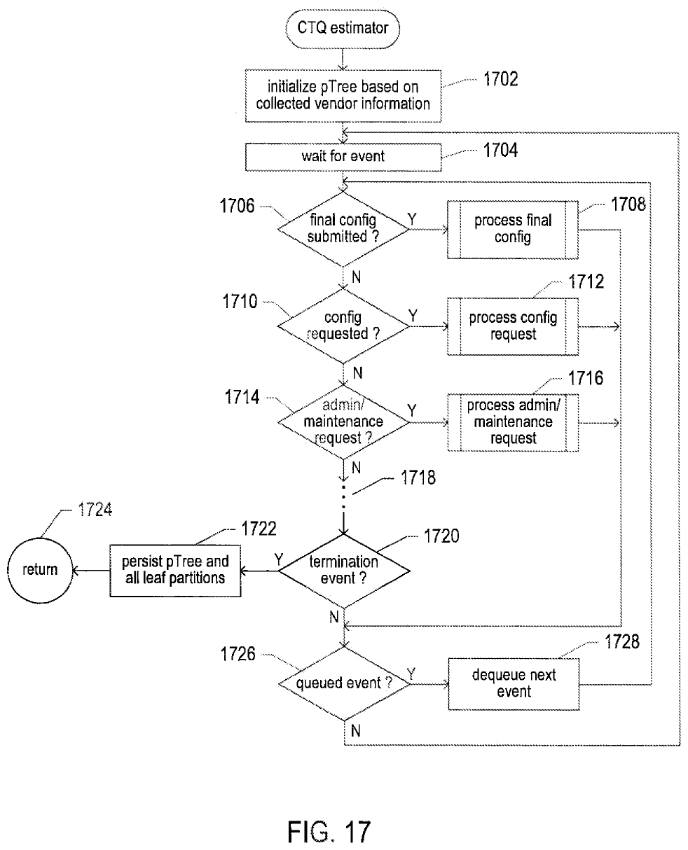

FIG. 17 is the first in a series of control-flow diagrams that illustrate one implementation of the currently disclosed CTQ estimator. FIG. 17 shows a high-level control-flow diagram for the basic event-handling loop that implements the currently disclosed CTQ estimator. In step 1702, the CTQ estimator is initialized by initializing the pTree data structure as discussed above with reference to FIGS. 11-13. In certain implementations, the initialized pTree data structure includes a single node and a single, initial model partition as discussed above with reference to FIG. 13. The initial model partition, as discussed above with reference to FIG. 11, includes a model (1136 in FIG. 11) with component-model expressions generated from vendor-supplied information, developer-supplied information, and other information sources. As discussed above, both the forms and the coefficient values for the component-model expressions are generated during the initialization step 1702. Then, in step 1704, the CTQ estimator waits for the occurrence of a next event. When the next event is the reception of a final-configuration report submitted by a client, as determined in step 1706, the handler “process final config” is called, in step 1708. Otherwise, when the next occurring event is a request for a list of the quantities of component types for a desired private-5G-network installation, as determined in step 1710, the handler “process config request” is called, in step 1712. Otherwise, when the next occurring event is one of various different types of administration and maintenance requests, as determined in step 1714, a handler for such requests is called in step 1716. Ellipsis 1718 indicates that additional types of events are generally handled by a CTQ estimator. When a termination event occurs, as determined in step 1720, the CTQ estimator persists the pTree data structure, including the generated forms of the component-model expressions and all of the leaf model partitions, in step 1722, and then terminates, in step 1724. Following handling of the next occurring event, in the case that the next occurring event was not a termination event, the CTQ estimator determines, in step 1726, whether or not another event has occurred and has been queued in an event queue for handling. If so, the next event is dequeued, in step 1728, and control returns to step 1706 for processing of the next event. Otherwise, control returns to step 1704 where the CTQ estimator waits for the occurrence of a subsequent event.

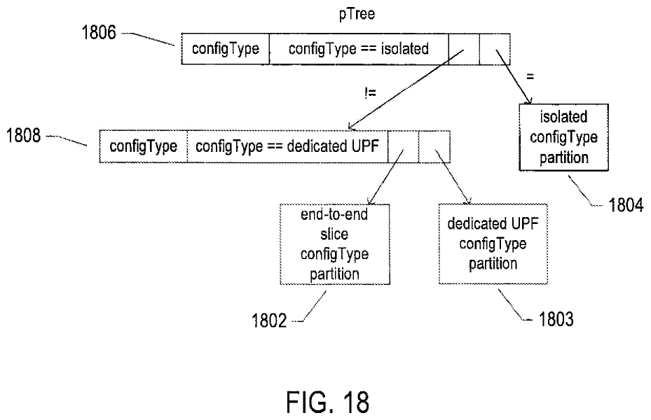

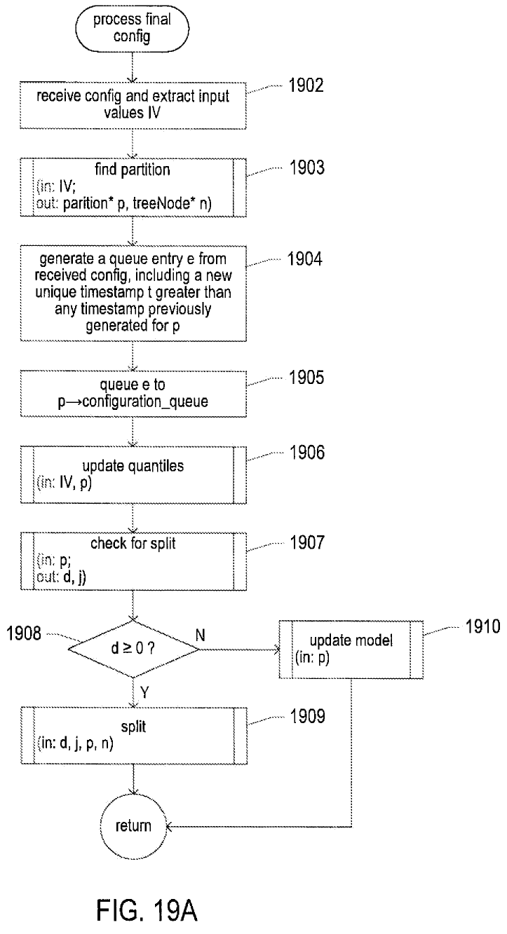

FIG. 18 shows an alternative form for the initial pTree data structure generated in step 1702 of FIG. 17. In this case, the input parameter configType indicates one of three quantized values that represent the three possible classes of installations, each represented by a fairly unique initial model partition 1802-1804. Thus, this initial pTree data structure includes two nodes 1806 and 1808 and a traversal of the pTree data structure will result in selection of one of the three initial model partitions. Of course, as additional data is accumulated from final-configuration reports submitted by clients, the initial model partitions may be successively partitioned to generate a much larger tree with more nodes and leaf nodes.

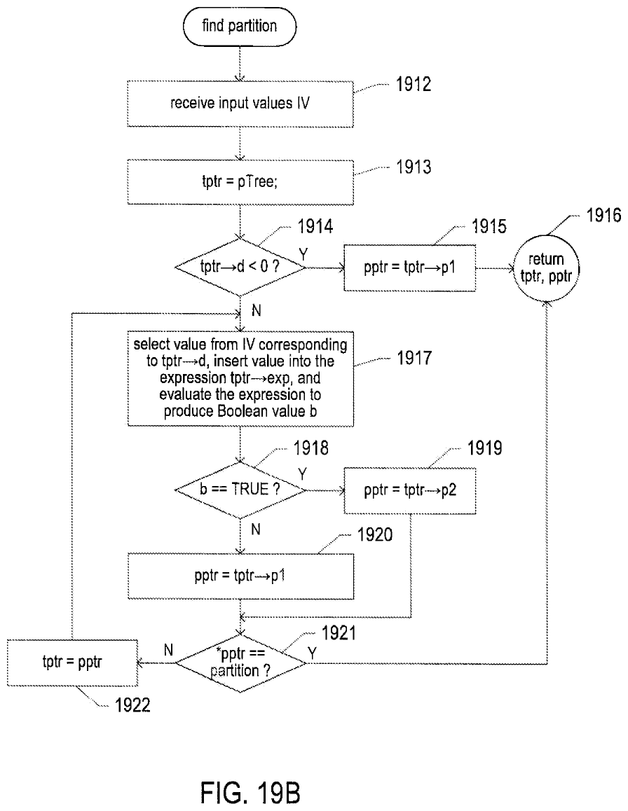

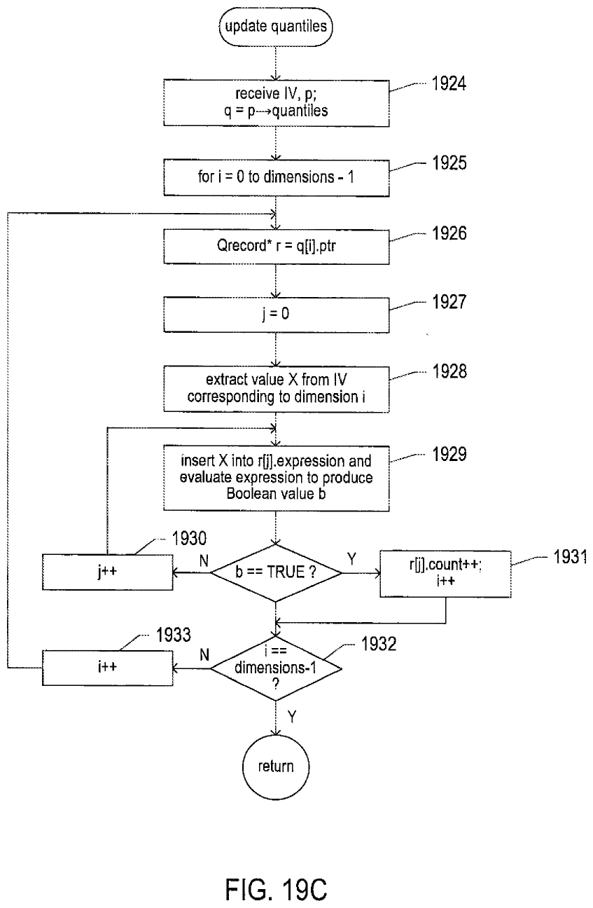

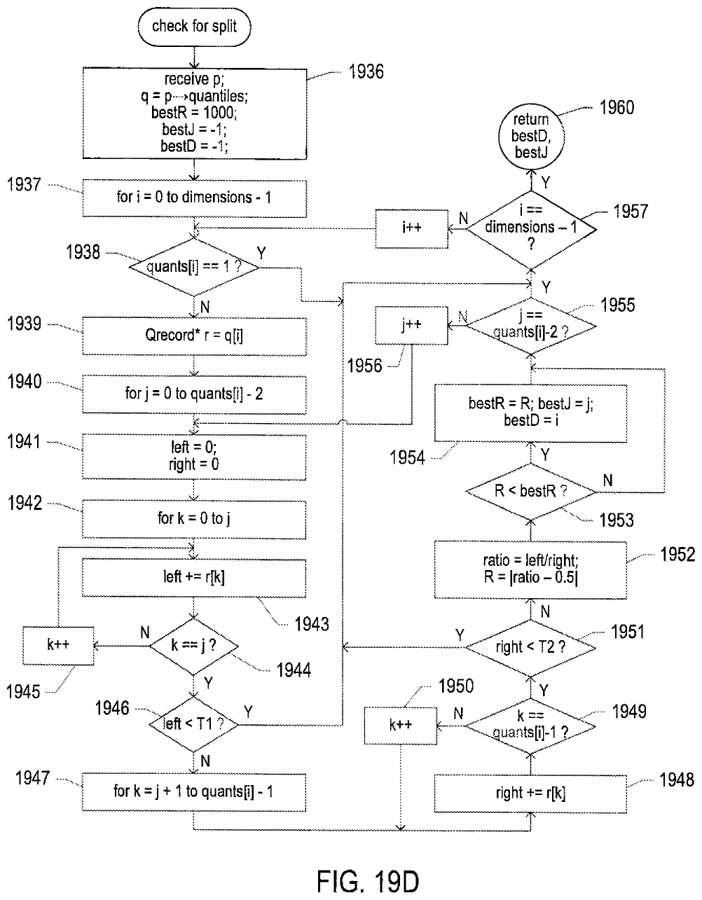

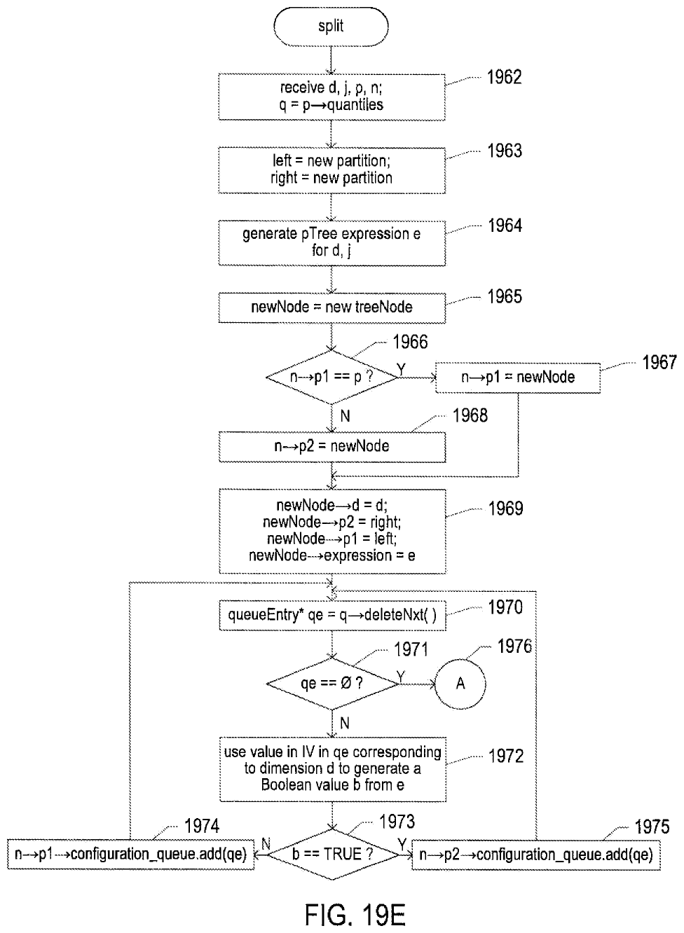

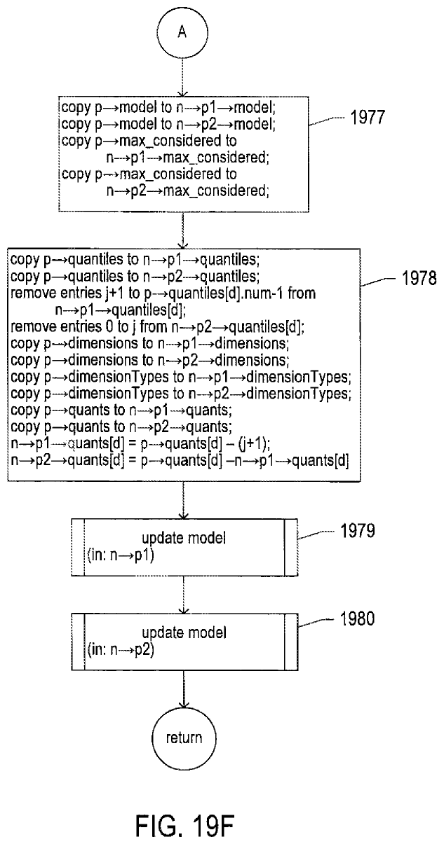

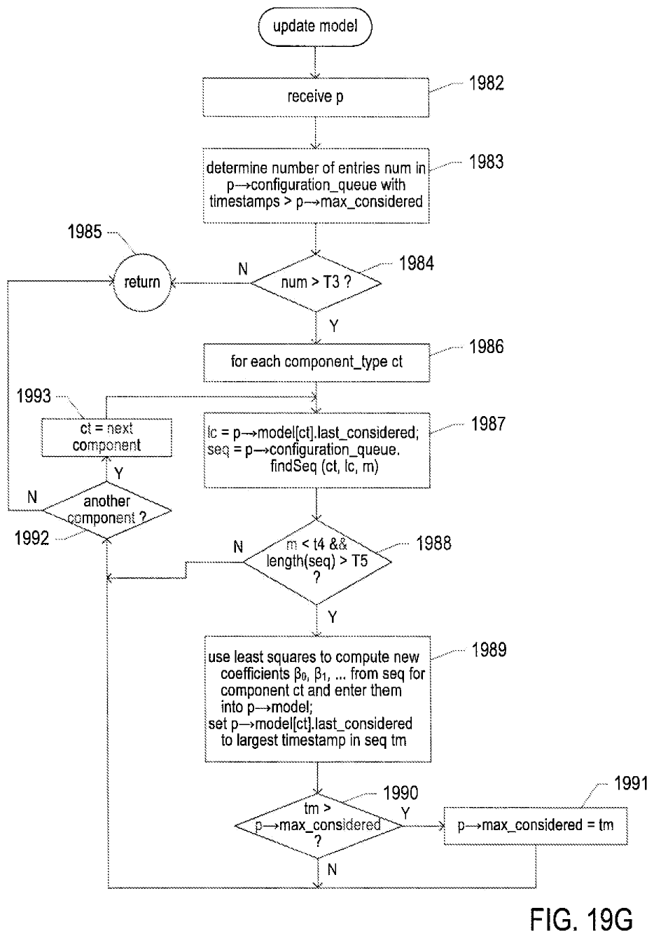

FIGS. 19A-G provide control-flow diagrams that illustrate implementation of the two main handlers 1708 and 1712 called from the event loop illustrated in FIG. 17. A highest-level control-flow diagram for the handler “process final config” is shown in FIG. 19A. In step 1902, the handler “process final config” receives a final-configuration report from which the included set of input values IV is extracted. In step 1903, a routine “find partition” is called to locate the model-partition leaf node in the pTree data structure corresponding to the set of input values IV. In step 1904, a new queue entry e is generated from the received final-configuration report. The new queue entry e includes a new unique timestamp with a larger value than any previously generated timestamp for queue entries included in the configuration queue. In step 1905, the new queue entry e is added to the configuration queue. In step 1906, a routine “update quantiles” is called to update the quantiles data structure in the model partition, identified in step 1903, referenced by model-partition pointer p. In step 1907, the routine “check for split” is called to determine whether or not a partitioning of the model partition referenced by partition pointer p is now warranted. The routine “check for split” returns an indication of a dimension, or parameter and a quantized level within this dimension that specify the partition, when a partition is warranted, and otherwise returns a dimension value less than 0. When a partition has been determined to be warranted, as determined in step 1908, a routine “split” is called in step 1909 to carry out a partition of the model-partition referenced by partition pointer p. Otherwise, the routine “update model” is called, in step 1910, to determine whether or not the model represented by the model-partition referenced by partition pointer p should now be updated and, if so, to carry out the update.

FIG. 19B provides a control-flow diagram for the routine “find partition,” called in step 1903 of FIG. 19A. In step 1912, the routine “find partition” receives a set of input values IV. Then, in step 1913, a local variable tptr is set to the value of the pointer pTree. When tptr references a pTree node in which the d field has a value less than 0, as determined in step 1914, the pTree data structure includes only a single node in the single initial model partition and therefore the routine “find partition” sets another local variable pptr to reference the initial model partition, in step 1915, and returns, in step 1916. The routine “find partition” returns a pointer to the node in the pTree data structure that references the identified model partition as well as a pointer to the identified model partition. Otherwise, in step 1917 and, the routine “find partition” selects a parameter value from the received set of input values IV corresponding to the dimension in the d field of the pTree node referenced by tptr, extracts the expression in the exp field of the pTree node referenced by tptr, enters the selected value into the expression, and evaluates the expression to produce a Boolean value b. When the Boolean value b is TRUE, as determined in step 1918, the routine “find partition” sets local variable pptr to the value stored in the p2 field of the pTree node referenced by tptr. Otherwise, in step 1920, the routine “find partition” sets local variable pptr to the value stored in the p1 field of the pTree node referenced by tptr. When local variable pptr references a model partition, as determined in step 1921, the routine “find partition” has found a leaf node corresponding to the received input values IV and therefore returns, in step 1916. Otherwise, in step 1922, the routine “find partition” sets the local variable tptr to the value stored in local variable pptr and control returns to step 1917 to continue a traverse of the pTree data structure. Thus, the routine “find partition” traverses the pTree data structure from the root to a model-partition leaf node and returns a pointer to that leaf node along with a pointer to the pTree node that contains a reference to the identified model-partition leaf node.

FIG. 19C provides a control-flow diagram for the routine “update quantiles” called in step 1906 of FIG. 19A. In step 1924, the routine “update quantiles” receives a set of input values IV and a pointer p to a model partition. In an outer for-loop of steps 1925-1933, each type of parameter, or dimension, is considered. In step 1926, local variable r is set to reference an array of Qrecord data structures pointed to by an entry in the quantiles array, discussed above with reference to FIG. 11, corresponding to the currently considered dimension. In an inner loop of steps 1927-1930, each entry, indexed by inner-loop variable j, in the array of Qrecord data structures, referenced by local variable r, is considered. The expression in the currently considered Qrecord entry is evaluated following insertion of the value of the currently considered dimension extracted from IV into the expression, in step 1929. When evaluation of the expression returns the Boolcan value TRUE, as determined in step 1930, the count field of the currently considered Qrecord entry is incremented, in step 1931, and the inner loop terminates. Otherwise, in step 1930, the inner-loop variable j is incremented and control returns to step 1929. The outer for-loop continues to iterate until all of the dimensions have been considered.

FIG. 19D provides a control-flow diagram for the routine “check for split,” called in step 1907 of FIG. 19A. In step 1936, the routine “check for split” receives a pointer to a model partition p, sets a local pointer variable q to reference the quantiles data structure in that partition, sets local variable bestR to a large integer value, sets local variable bestJ to −1, and sets local variable bestD to −1. Local variable bestR is used to store the best ratio of counts across a dimension partition observed, local variable bestJ is used to store the best Qrecord index for partitioning a dimension, and bestD is used to store the best dimension for partitioning. The outer for-loop of steps 1937-1959 considers each dimension or input-parameter type. When the number of quantized levels for the currently considered dimension is equal to 1, as determined in step 1938, control flows to step 1957 where the routine “check for split” determines whether or not the outer for-loop has completed. If so, the routine “check for split” terminates in step 1960. Otherwise, the outer-for-loop variable i is incremented, in step 1959, and control returns to step 1938 for a next iteration of the outer for-loop. In step 1939, local variable r is set to point to the first Qrecord entry in the array of Qrecord entries corresponding to the currently considered dimension. In a next-innermost for-loop of steps 1940-1956, the loop variable/indexes, in order, all but the final Qrecord entry in the array corresponding to the currently considered dimension. The loop variable j is used to partition the array into a left and a right portion. In step 1941, local variables left and right are both set to 0. These variables keep track of the number of counts in the Qrecord entries in the left and right portions of the array corresponding to the currently considered dimension. In the innermost for-loop of steps 1942-1946, the sum of the values in the count fields of the Qrecord entries in the left portion of the array is determined and, in the innermost for-loop of steps 1947-1951, the sum of the values in the counts fields of the Qrecord entries in the right portion of the array is determined. When the sum is less than a threshold value T1, as determined in step 1946, the current iteration of the next-innermost for-loop of steps 1940-1956 terminates, since there must be a threshold number of counts in each of the left and right portions of the array in order for the currently considered dimension to be partitioned. Similarly, when the sum is less than a threshold value T2, as determined in step 1951, the current iteration of the next-innermost for-loop of steps 1940-1956 terminates, since there must be a threshold number of counts in each of the left and right portions of the array in order for the currently considered dimension to be partitioned. In step 1952, the ratio of the counts in the left portion to the counts in the right portion of the array is computed and a value R is computed as the absolute value of the ratio minus 0.5. The most desirable R value is thus 0, corresponding to an even balance between the left and right portions of the array. When the computed value R is less than the value stored in local variable bestR, as determined in step 1953, the computed value R is the best R value so far observed and therefore, in step 1954, this value stored in local variable bestR, and local variables bestJ and bestD are updated to store the current values of the loop variables j and i, respectively. When j is equal to the index of the second-to-last entry in the Qrecord array corresponding to the currently considered dimension, as determined in step 1955, the next-innermost loop of steps 1940-1956 has finished and control therefore flows to step 1957. Otherwise, the loop variable j is incremented in step 1956 and control returns to step 1941 for a next iteration of the next-innermost loop of steps 1940-1956. As discussed above, step 1957 determines whether or not the outer for-loop has terminated. When the outer for-loop is terminated, the routine “check for split” returns the value stored in local variables bestD and BestJ.

FIGS. 19E-F provide control-flow diagrams for an implementation of the routine “split,” called in step 1909 of FIG. 19A. In step 1962, the routine “split” receives an indication of a dimension d, an indication of a quantization level for a partition within the dimension j, a pointer to a model partition p, and a pointer to a pTree node n. A local variable q is set to reference the quantiles data structure in the model partition referenced by pointer p. In step 1963, two new model partitions are created and local variables left and right are set to reference them. In step 1964, an expression e for a new pTree node is generated for the partition of dimension d between quantization level j and quantization level j+1. In step 1965, a new pTree node is created. When the field p1 in the pTree node referenced by pointer n points to the model partition referenced by pointer p, as determined in step 1966, the field p1 in the pTree node referenced by pointer n is set to reference the new pTree node created in step 1965, in step 1967. Otherwise, the field p2 in the pTree node referenced by pointer n is set to reference the new pTree node created in step 1965, in step 1968. In step 1969, the pTree node referenced by pointer n is initialized. In a loop of steps 1970-1976, all of the entries in the configuration queue in the model partition referenced by pointer p are deleted from the configuration queue and entered into the configuration queue of the appropriate model partition of the two new model partitions created in step 1963. Following the loop of steps 1970-1976, in step 1977 of FIG. 19F, the model in the model partition referenced by pointer p is copied to both of the new model partitions. In step 1978, the information in the quantiles data structure model in the model partition referenced by pointer p is copied to both of the new model partitions, with adjustments made to reflect the partition of dimension d. Finally, in steps 1979 and 1980, the routine “update model” is called for both of the two new model partitions. The model partition referenced by pointer p is garbage collected.

FIG. 19G provides a control-flow diagram for the routine “update model.” called in steps 1979-1980 of FIG. 19F and in step 1910 of FIG. 19A. In step 1982, the routine “update model” receives a pointer p that references a model partition. In step 1983, the routine “update model” determines the number of entries in the configuration queue within the model partition referenced by pointer p with timestamps greater than the timestamp contained in the integer max_considered (1138 in FIG. 11). When the determined number of entries is less than or equal to a threshold number 73, as determined in step 1984, the routine “update model” returns in step 1985, since there must be a threshold number of recently queued entries to justify updating the model. Otherwise, in the for-loop of steps 1986-1993, each different type of component ct is considered. In step 1987, the best subsequence of recently received queue entries for computing a set of coefficients for the currently considered component is determined by a call to a function similar to the function findMinSeq, discussed above with reference to FIGS. 14-15E. When the computed metric value for the best subsequence is less than a threshold value T4 and the number of entries in the subsequence is greater than a threshold value 75, the sequence can be used for computing new coefficients for the component-model expression for the currently considered component. Otherwise, control flows to step 1992, which determines whether or not an additional iteration of the for-loop of steps 1986-1993 should be undertaken. When the subsequence can be used for computing new coefficients, the least-squares method discussed above with reference to FIG. 16 is employed, in step 1989, to generate new coefficients for the component-model expression, and those new components are inserted into the model and the last_considered field in the row of the model corresponding to the currently considered component type is set to the largest timestamp in the subsequence of entries. When the largest timestamp in the subsequence is greater than the value stored in max_considered, as determined in step 1990, max_considered is updated to contain the largest timestamp in the subsequence in step 1991. The for-loop of steps 1986-1993 iterates until all of the component types have been considered.

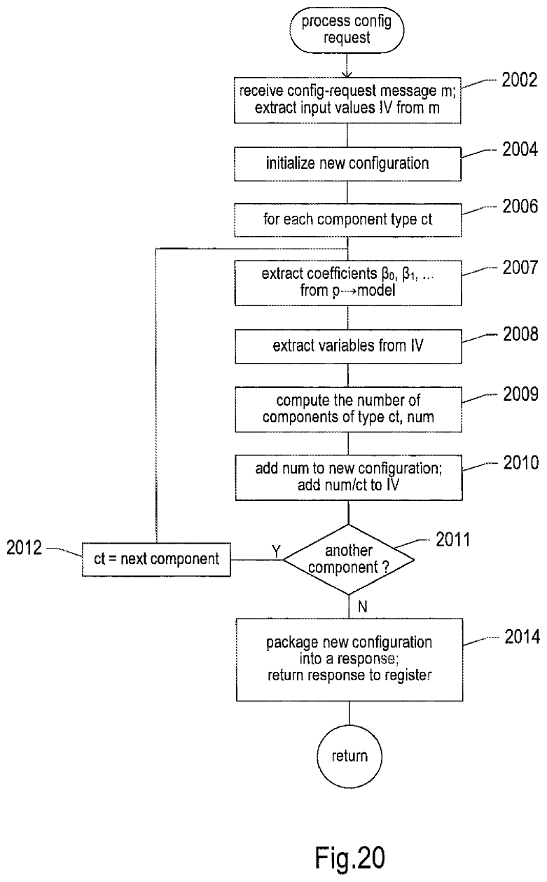

FIG. 20 provides a control-flow diagram for the routine “process config request” called in step 1712 of FIG. 17. In step 2002, the routine “process config request” receives a configuration-request message m and extracts a set of input values IV from the message m. In step 2004, a new configuration or list of component quantities is initialized. In the for-loop of steps 2006-2012, each component type ct is considered. The component-model expression for the currently considered component type is used to compute an estimated number of components of the currently considered component type needed for the installation characterized by the input variables IV in steps 2007-2010. The values of all variables in the component-model expression are obtained or computed from either the set of input values IV, from component quantities estimated for other components, or from both. In step 2014, the new configuration is packaged into a response message which is then returned to the requester. Note that component types for which the estimated number of needed instances is 0 may be removed from the configuration or list of component quantities for purposes of clarity and brevity.

Although the present invention has been described in terms of particular embodiments, it is not intended that the invention be limited to these embodiments. Modification within the spirit of the invention will be apparent to those skilled in the art. For example, any of a variety of different implementations of the currently disclosed methods and systems can be obtained by varying any of many different design and implementation parameters, including modular organization, programming language, underlying operating system, control structures, data structures, and other such design and implementation parameters. A CTQ estimator may be implemented in a stand-alone computer system, within a data center or cloud-computing facility, including within a virtual machine hosted by a server within a data center or cloud-computing facility, or in various other types of processor-controlled devices and systems.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A component-types-and-quantities-estimator system (“CTQ estimator”) that estimates the types and quantities of system components needed for a system installation, the CTQ estimator comprising:
a computing platform that provides an execution environment for CTQ-estimator functionality, the computer platform implemented within one or more computer systems that each includes one or more processors, one or memories, and one or more mass-storage appliances or devices; and
computer instructions, stored in one of the one or more memories, that, when executed in the execution environment, control the one or more computer systems to:
receive a request for a list of component types and quantities for installation of a system, the received request including a set of parameter values, and return the requested list of component types and quantities; and
receive a final-configuration report that includes a list of component types and quantities installed in a system installation and a set of parameter values and stores the final-configuration report for use in refining component models used for determining the component types and quantities for installation of systems and for partitioning a model, comprising component models, that corresponds to a parameter-value space or subspace into sub-models corresponding to different parameter-value subspaces.

2. The CTQ estimator of claim 1 wherein each component type is associated with a single-variate or multivariate polynomial expression used to estimate the quantity of components of the component type needed for the system installation.

3. The CTQ estimator of claim 2
wherein the values of variables in the polynomial expression are computed from the values of parameters and/or from estimated component quantities; and
wherein the coefficients in the polynomial expression are initially generated from vendor-supplied information, developer-supplied information, and other information sources for component quantities in system installations and stored in the component model for the component type.

4. The CTQ estimator of claim 3 wherein component models are refined using component quantities returned in final-configuration reports.

5. The CTQ estimator of claim 4 wherein a component model for a component type is refined using a least-squares method that minimizes the squared differences of component quantities estimated from the polynomial expression associated for the component type and an average of the reported component quantities for the component type.

6. The CTQ estimator of claim 3 wherein a model comprises an ordered set of component models, one component model for each type of component.

7. The CTQ estimator of claim 3 wherein the set of component models is ordered so that, for a particular component model that includes a variable computed from an estimated quantity of a different component type, the component model for the different component type precedes the particular component model in the ordered set of component models.

8. The CTQ estimator of claim 1 wherein, upon receiving the request for a list of component types and quantities for installation of a system from a requestor entity, the CTQ estimator
extracts the set of parameter values from the request;
uses the set of parameter values to identify a model that represents a class of system installation characterized by the set of parameter values;
for each component type for which a component model is included in the model,
uses the component model for the component type to generate an estimate of the quantity of components of the component type needed for the system installation;
includes the estimated component quantities generated from the component models in a list of component types and quantities; and
returns the list of component types and quantities to the requestor entity.

9. The CTQ estimator of claim 9 wherein the CTQ estimator uses the component model for the component type to generate an estimate of the quantity of components of the component type needed for the system installation by using the polynomial expression for the component type to compute the component quantity by replacing each variable in the polynomial expression with a parameter value or with a component quantity estimated for a different component type and replacing each coefficient in the polynomial expression by a current value for the coefficient stored in the component model.

10. The CTQ estimator of claim 1 wherein the CTQ estimator includes a comprehensive data structure that comprises a set of model-partition data structures, each model-partition data structure including:
a model corresponding to a particular parameter-value space or subspace, the model comprising a set of component models for each component type;
a parameter-value-space data structure that represents the dimensions and quantization levels for the parameter-value space or subspace, each dimension corresponding to a parameter, each dimension associated with a number of quantization levels computed from values of the parameter, each quantization level associated with an expression used to determine whether a value for the parameter falls into the quantization level, and a count of the processed final-configuration reports that include a value that falls into the quantization level; and
stored final-configuration reports for system installations associated with parameter values that fall within the particular parameter-value space or subspace.

11. The CTQ estimator of claim 10 wherein the CTQ estimator traverses the comprehensive data structure to identify the model-partition data structure corresponding to a set of parameter values.

12. The CTQ estimator of claim 11 wherein, when the parameter-value space or subspace associated with a model partition can be partitioned into two parameter-value subspaces that each corresponds to at least a threshold number of final-configuration reports, the CTQ estimator replaces the model partition with two new model partitions that represent the two parameter-value subspaces so that, over time, the CTQ estimator contains increasingly specific models for smaller and more specific parameter-value subspaces.

13. The CTQ estimator of claim 12 wherein the comprehensive data structure is a tree-like data structure with model partitions as leaf nodes and internal nodes containing expressions that evaluate to a Boolean value when evaluated using a parameter value selected from a set of parameter values.

14. A method that automatically estimates the types and quantities of system components needed for a system installation, the method comprising:
receiving a request for a list of component types and quantities for installation of a system, the received request including a set of parameter values;
using the set of parameter values to traverse a comprehensive data structure to identify a model that represents a class of system installation characterized by the set of parameter values;
for each component type for which a component model is included in the model,
using the component model for the component type and a polynomial expression associated with the component type to generate an estimate of the quantity of components of the component type needed for the system installation;
including the estimated component quantities generated from the component models in a list of component types and quantities; and
returning the list of component types and quantities to the requestor entity.

15. The method of claim 14 wherein the model represents a parameter-value space or subspace corresponding to a particular class of system installations and comprises an ordered set of component models, each corresponding to a component type, that each contains a set of one or more coefficient values for the polynomial expression associated with the associated component type.

16. The method of claim 15 wherein using the component model for the component type and a polynomial expression associated with the component type to generate an estimate of the quantity of components of the component type needed for the system installation further comprises:
replacing each variable in the polynomial expression with a parameter value or with a component quantity estimated for a different component type;
replacing each coefficient in the polynomial expression by a current value for the coefficient stored in the component model for the component type; and
evaluating the polynomial expression with variable values and coefficient values to generate an estimated component quantity.

17. The method of claim 15 wherein comprehensive data structure comprises a set of model-partition data structures, each model-partition data structure including:
a model corresponding to a particular parameter-value space or subspace;
a parameter-value-space data structure that represents the dimensions and quantization levels for the particular parameter-value space or subspace, each dimension corresponding to a parameter, each dimension associated with a number of quantization levels computed from values of the parameter, each quantization level associated with an expression used to determine whether a value for the parameter falls into the quantization level, and a count of the processed final-configuration reports that include a value that falls into the quantization level; and
stored final-configuration reports for system installations associated with parameter values that fall within the particular parameter-value space or subspace.

18. The method of claim 17 further comprising, when the parameter-value space or subspace associated with a model partition can be partitioned into two parameter-value subspaces that each corresponds to at least a threshold number of final-configuration reports, replacing the model partition with two new model partitions that represent the two parameter-value subspaces so that, over time, the comprehensive data structure contains increasingly specific models for smaller and more specific parameter-value subspaces.

19. The CTQ estimator of claim 12 wherein the comprehensive data structure is a tree-like data structure with model partitions as leaf nodes and internal nodes containing expressions that evaluate to a Boolean value when evaluated using a parameter value selected from a set of parameter values.

20. A physical data-storage device that contains a set of computer instructions that, when executed by one or more processors of one or more computer systems, each having one or more memories and one or more mass-storage device, control the one or more computer systems to:
receive a request for a list of component types and quantities for installation of a system, the received request including a set of parameter values;
use the set of parameter values to traverse a comprehensive data structure to identify a model that represents a class of system installation characterized by the set of parameter values;
for each component type for which a component model is included in the model,
using the component model for the component type and a polynomial expression associated with the component type to generate an estimate of the quantity of components of the component type needed for the system installation;
include the estimated component quantities generated from the component models in a list of component types and quantities; and
return the list of component types and quantities to the requestor entity.
